(19) United States
(12) Patent Application Publication
(10) Pub. No.: US 2021/0174150 A1
(43) Pub. Date: Jun. 10, 2021

(54) Automated Classification Engine with Human Augmentation

(71) Applicant: Waste Repurposing International, Inc., Austin, TX (US)

(72) Inventors: Christopher Barnard Ripley, Lichtfield, CT (US); Joshua Bennett Groves, Sisters, OR (US); Charles Bartol Vallely, Austin, TX (US)

(73) Assignee: Waste Repurposing International, Inc., Austin, TX (US)

(21) Appl. No.: 16/706,714

(22) Filed: Dec. 7, 2019

(51) Int. Cl. G06K 9/62; G06N 20/00; G06F 9/54; G06Q 10/08

(52) U.S. Cl. CPC G06K 9/6267; G06K 9/6262; G06Q 10/0832; G06F 9/542; G06N 20/00

(57) ABSTRACT

A system may include an interface configured to communicate with a network and a processor coupled to the interface. The processor may be configured to determine a reliability value of one or more classifications associated with a product is below a threshold value and provide an alert including product data to a first computing device associated with a human operator. The product data may include one or more of product information, the reliability value, and the one or more classifications. The alert may include one or more controls accessible by the human operator to edit the product data. The processor may receive the product data from the first computing device, store the product data in a data store, and provide data related to the product data to a second computing device that is associated with a second human operator.

### FIELD

The present disclosure is generally related to automated classification of unsaleable items, and more particularly to automated classification using a classification engine and including human augmentation at different stages within a classification process.

### BACKGROUND

Chemicals are widely used to enhance and improve the lives of people. Unfortunately, some of the chemicals may have the potential for adversely effecting people or the environment. As a result, various countries and governmental organizations have developed laws or safety regulations for keeping our roads, waterways, and airways safe and for maintaining our environment. In the United States, the Department of Transportation regulates the transportation of household hazardous waste products by land, sea, and air. Additionally, state and local governments may also issue regulations related transportation of such products. In some cases, such regulations may require information to be prepared and communicated to those transporting or using chemicals, via labels or safety data sheets (SDS).

Additionally, governmental agencies have promulgated rules and relations related to the safe disposal of such products. For example, the Environmental Protection Agency has issued regulations related to the disposal of household hazardous waste products. In some instances, state governments, county agencies, and local governments may also regulate disposal of household hazardous waste products. For example, certain types of products, such as chemical products, paint products, and other products (including those that cannot be identified), may sometimes be classified as hazardous. Transportation regulations may determine costs, packaging, and other parameters for transporting such products. It should be appreciated that such regulations may vary based on the packing, the quantity, the classification, and so on.

### SUMMARY

Embodiments of systems, methods, and devices described herein may combine automation of classifications of unsaleable products with selective engagement of human operators at various stages and for various reasons to determine classifications (transportation, hazard, waste, business logic, and other classifications) for proper handling of the products. In some implementations, the systems, methods, and devices may selectively involve human operators, for example, to retrieve further information or to review, edit, confirm, or reject one or more automatic classifications. Other implementations are also possible.

In some implementations, the system may receive product information corresponding to an unsaleable product. The system may extract, transform, and load the product information into a temporary table, may optionally retrieve further information from one or more data sources to populate the temporary table, and may evaluate the extracted and retrieved product information to determine whether the information can be used to perform automatic classifications. When the product information is insufficient to perform automatic classifications, the system may provide an interface to a selected user to prompt the user to provide further information. The system may provide the interface by sending an alert, by providing a popup window within an application, or in a different manner. The interface may include data and may include one or more controls accessible by a user to enter further information about the product and to submit the information to the system.

When the original or the further product information is enough, the system may automatically determine chemical data and one or more classifications associated with an unsaleable product. The classifications may include one or more regulatory classifications, such as hazard classifications, transportation classifications, waste classifications, other classifications, or any combination thereof. The classifications may also include one or more business logic classifications and other information. In some implementations, the system may determine a reliability value for each of the classifications that is indicative of the accuracy of the determination. If the reliability value is below a threshold reliability, the system may provide an interface to one or more expert or super users to review the classification data, to edit the data, and to confirm or reject the classifications. If the classification is rejected, the system may send an alert to a requester that the product information was insufficient to reliably perform the classification operations. Alternatively, if the classification is confirmed (with or without human editing), the system may store the classification data and may provide the classification data to the requester.

In some implementations, a user (requester) may submit product information to the system, such as by accessing an application running on his or her computer, visiting a web page, or another method. The product information may include an image of the product, a barcode scan of the product, a universal product code (UPC) for the product, other information, and so on. The system may process the received product information and optionally retrieve related information. If the received and optional related information include enough data to determine the chemical composition of the product, the system may automatically determine one or more classifications associated with the product based in part on the chemical composition data. The system may also determine reliability values for each of the classifications and, if a classification value is less than a threshold value, the system may send an alert to an expert user to review or edit, and optionally confirm or reject the classifications. Other implementations are also possible.

In some embodiments, the system may receive information about a product and, in response to receiving the information, may determine a safety data sheet (SDS) based on the received information. If the data store does not already include the SDS, the system may search one or more data sources for the SDS. If the SDS is not found, the system may provide an interface to a human operator to search for the SDS. If the SDS is not found, the system may provide data to the requester indicating that more information is needed to classify the product. Otherwise, if the SDS is found, the system may calculate a quality of the SDS. If the quality of the SDS is below a first quality threshold or if the quality value indicates that multiple SDS forms are included in a single document, the SDS may be provided to a human operator to extract data from the SDS or to sort the multiple SDS forms into a single document, which may then be resubmitted for determination of the quality of the SDS.

In some implementations, the system may automatically parse the SDS to extract data. The system may determine if the extracted SDS data is missing one or more attributes that may be important to determining classifications. If one or more attributes are missing, the system may provide the parsed data and the SDS to a human operator for parsing. If successful or if the parsed data is not missing the one or more attributes, the system may synchronize and validate the parsed data. The system may then determine first principles regulatory classifications based on the parsed data and may then synchronize and validate the first principles regulatory classifications. The system may then use a machine learning system to determine one or more regulatory classifications, which may be synchronized and validated. The system may then determine reliability values for the regulatory classifications. If the reliability values are below a threshold value, the system may forward the classifications to a human operator for review, editing, and optional confirmation of the classifications. The system may then store the regulatory classifications in a data store.

In some implementations, the system may utilize a disposal taxonomy, which may map the regulatory classifications to disposal taxonomy. If the disposal taxonomy is automatically assigned, the assignments may be stored in the data store. Otherwise, the disposal taxonomy data and the regulatory classifications may be provided to a human operator to assign the disposal taxonomy. In some implementations, the disposal taxonomy may simplify a process of sorting products into bins and waste profiling. The disposal taxonomy may describe what a product is. For example, a waste product may be identified in the disposal taxonomy as a battery, such as a Lithium ion battery, rather than a regulatory classification. In some implementations, even if the system is unable to assign a regulatory classification, the disposal taxonomy may still be assigned.

In some implementations, the system may apply customer-specific rules that may utilize one or more of the product attributes of a product, regulatory classifications associated with the product, disposal taxonomy assignments, or other information to determine a bin into which the product is to be sorted or to determine a waste profile for the product. Data related to the determination may be provided to a user to guide the user to handle the product properly for waste disposal purposes. In some implementations, the data may be presented on a display of a single-item sorting device, within a web-based portal of company (such as a retailer, a wholesaler, a transporter, and so on), within an interface presented on a computing device (such as a smartphone, a tablet computer, or another computing device), and so on. The computing device of a user may interact with the system via a synchronization services application programming interface (API). Other implementations are also possible.

In some embodiments, a system may include an interface configured to communicate with a network and a processor coupled to the interface. The processor may be configured to determine a reliability value of one or more classifications associated with a product is below a threshold value and provide an alert including product data to a first computing device associated with a human operator. The product data may include one or more of product information, the reliability value, and the one or more classifications. The alert may include one or more controls accessible by the human operator to edit the product data. The processor may receive the product data from the first computing device, store the product data in a data store, and provide data related to the product data to a second computing device that is associated with a second human operator.

In other embodiments, a system may include an interface configured to communicate with a network and a processor coupled to the interface. The processor may be configured to receive product information from a first computing device and automatically determine one or more classifications and reliability values based on the product information. Each of the reliability values may be associated with one of the one or more classifications. When the reliability value is below a threshold value, the processor may selectively provide an alert to a second computing device that is associated with a Turk. The alert may include one or more of the product information, the one or more classifications, or reliability values and including one or more controls accessible by the Turk to edit or confirm a selected one of the one or more classifications. The processor may receive data from the second computing device based on selection of the one or more controls and provide data to the first computing device based on the one or more classifications.

In still other embodiments, a system may include an interface configured to communicate with a network and a processor coupled to the interface. The processor may be configured to receive product information related to a product, determine one or more classifications and a reliability value for each of the one or more classifications based on the product information, and provide an alert to a first computing device when the reliability value for at least one of the one or more classifications is below a reliability threshold. The alert may include data related to the product and may include one or more controls accessible by a human operator to review the one or more classifications. The processor may be configured to receive data confirming the one or more classifications from the first computing device and provide classification data related to the product to a second computing device.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a system of classifying a product, in accordance with certain embodiments of the present disclosure.

FIG. 2 depicts a system including of classifying a product, in accordance with certain embodiments of the present disclosure.

FIG. 3 depicts a system to classify a product, in accordance with certain embodiments of the present disclosure.

FIG. 4 depicts an embodiment of the classification system of FIGS. 1-3 to classify a product, in accordance with certain embodiments of the present disclosure.

FIG. 5 depicts an embodiment of a computing device that may be used with the classification systems of FIGS. 1-5, in accordance with certain embodiments of the present disclosure.

FIG. 6 depicts a flow diagram of a method of determining a classification of a product using automated systems and human operators, in accordance with certain embodiments of the present disclosure.

FIG. 7 depicts a flow diagram of a method of determining a classification of a product using automated systems and human operators, in accordance with certain embodiments of the present disclosure.

FIG. 8 depicts a flow diagram of a method of acquiring data for the classification system, in accordance with certain embodiments of the present disclosure.

FIG. 9 depicts a flow diagram of a method of evaluating a quality level of safety data sheet (SDS), in accordance with certain embodiments of the present disclosure.

FIG. 10 depicts a flow diagram of a method of determining one or more regulatory classifications), in accordance with certain embodiments of the present disclosure.

FIG. 11 depicts a flow diagram of a method assigning confidence values for the one or more regulatory classifications), in accordance with certain embodiments of the present disclosure.

FIG. 12 depicts a flow diagram of a method of determining disposal taxonomy mappings based on the product information or the regulatory classifications), in accordance with certain embodiments of the present disclosure.

FIG. 13 depicts a flow diagram of determining location-specific bin assignments or waste profiles) for a product, in accordance with certain embodiments of the present disclosure.

FIG. 14 depicts a system including a classification system and a plurality of customer-facing applications), in accordance with certain embodiments of the present disclosure.

While implementations are described in this disclosure by way of example, those skilled in the art will recognize that the implementations are not limited to the examples or figures described. The figures and detailed description thereto are not intended to limit implementations to the form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the word “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Embodiments of systems, devices, and methods are described below that may include an automated classification system that determines one or more parameters of a product, such as chemical composition data, classification data, other data, or any combination thereof. The systems, devices, and methods may be configured to automate certain aspects of the classification process while engaging humans to supplement the classification process. In some implementations, a classification system may receive product information, such as an image of a product, a name of the product, a weight of the product, a chemical description of the product, and so on. The classification system may automatically generate a complete or partial list of attributes and attribute values (data) for a new or existing product, which attribute values may be stored in a data store. In some implementations, the classification system may receive an image and other data and may use the received image and other data to retrieve related data from one or more data sources. The classification system may use the retrieved data to determine the chemical composition of the product, one or more regulatory classifications corresponding to the product, and so on.

In some implementations, the system may utilize machine learning, artificial intelligence, neural networks, or other enhanced computer decision-making components, which may automatically determine the chemical composition data, the regulatory classification data, other data, or any combination thereof. When a reliability of such automatically determined data is below a threshold or when the information is insufficient for the automated system to make reliable determinations, the system may engage one or more human operators. Other implementations are also possible.

In some implementations, the system may engage several types or levels human operators, such as 1) searchers or mechanical Turks, 2) super Turks having some training in reviewing classifications, and 3) expert Turks have extensive training and experience in reviewing classifications. At a first level, low-expertise (mechanical) human operators may be engaged to facilitate data acquisition, when text parsing mechanism fail or when there is insufficient information. the low-expertise human operators (mechanical Turks) may search one or more data sources to supplement received product information. At a second level, the system may engage higher-expertise (trained) human operators, who may be trained to perform simple classifications or to make initial classifications that can be verified by an expert. In some implementations, the trained human operators may complete a training regimen and pass a test indicative of a selected level of training with respect to reviewing, editing, and confirming or rejecting automatic classifications. At a third level, the system may engage expert human operators who can review, correct, and optionally corroborate various classifications. Such expert human operators may include individuals who have acquired and demonstrated knowledge of classifications over a period of time. Such expert Turks or expert human operators may have received training and may have a range of real-world experience in product classifications. The system may engage the human operators selectively in conjunction with the automatic classification process. Other implementations are also possible.

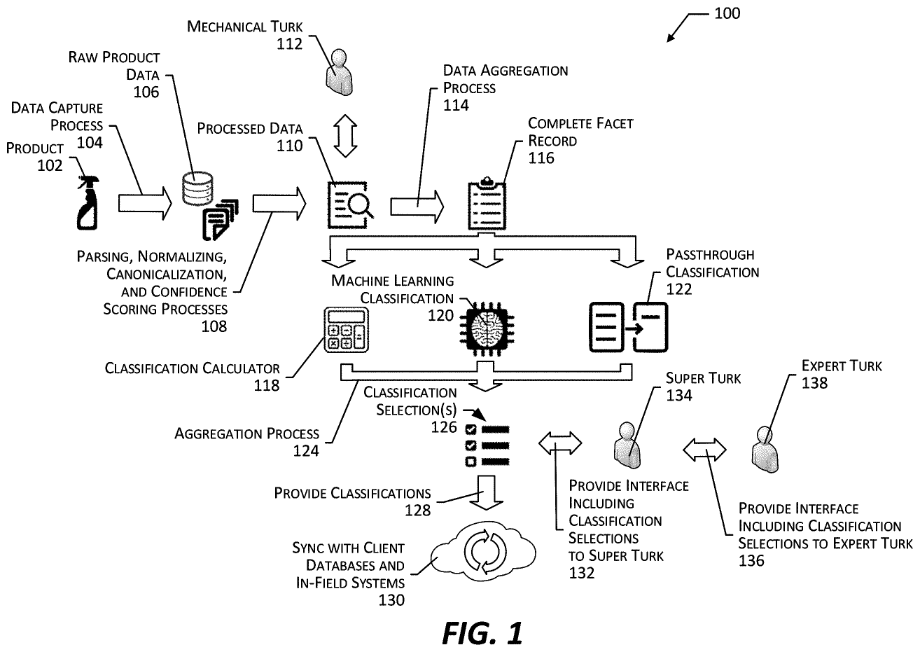

Embodiments of systems, devices, and methods are described below that may automatically classify a product by determining its chemical composition and then by applying the chemical composition to various classification rules to determine regulatory classifications. During the classification process, the system may determine if a parameter associated with the product, the determination about the product, or the classification of the product has a reliability value that is greater than a threshold reliability. If the reliability value is below the threshold reliability, the system may engage a human operator by sending an alert. One possible example of such as system is described below with respect to FIG. 1.

FIG. 1 depicts a system 100 to classify a product 102, in accordance with certain embodiments of the present disclosure. The product 102 may be a commercial product that is available for sale at a retail store or online. In some implementations, the product 102 may include retail products, unsaleable products, waste products, spoilage, or other types of items. other items, or any combination thereof. Unsaleable products may include products 102 with damaged packaging or products with torn shrink wrap or other issues that render such products unsaleable in a retail store, but with might otherwise be usable.

The system 100 may utilize a data capture process 104 to capture raw product data 106 corresponding to the product 102. The raw product data 106 can include one or more images of the product packaging, weight data, chemical composition data, location data, other data, or any combination thereof. In an example, a user may enter information at a keyboard, scan a barcode, capture images, or otherwise enter information about the product 102 using a computing device (such as a laptop computer, a tablet computer, a smartphone, or another computing device) and may provide the information to the system

The raw product data 106 can be processed through a parsing, normalization, canonicalization, and confidence scoring process 108 to produce processed data 110. The raw product data 106 may be parsed by extracting, transforming, and loading received data from the data capture process 104 into temporary tables or other data structures and organizing the data into fields that can subsequently be used for comparison and analysis. For example, the system 100 may receive data, such as text data, a universal product code (UPC), a photograph of the product, or any combination thereof. The system 100 may process the received data to extract information, which may be used to determine product information by automatically searching one or more data sources including a database of products. In some implementations, the system 100 may extract information received from a submitted a web form and may search one or more data sources based on the submitted data to determine the product information. Information retrieved from the data sources based on the search may be used to supplement the data in the temporary tables.

The normalization process may include automatically identifying and removing redundancies, converting abbreviations and alternative spellings into a consistent spellings and terminology, organizing non-structured data into structured data, and so on. The canonicalization process may include converting data that has more than one possible representation into a “standard”, “normal”, or “canonical” form. Such a conversion ensures that the data conforms to canonical rules, enabling searches and comparisons. The confidence scoring process includes determining a reliability value for each calculation. The reliability value may be a value between 0.00 and 1.00 that indicates an amount of potential error within a calculation or determination.

In some implementations, the system 100 may determine attributes associated with the product 102. The attributes may include chemical properties, intended use, packaging type and dimensions, physical properties, other information, or any combination thereof. In some implementations, the attributes of the product may include fundamental attributes, such as the chemical makeup, laboratory test data, intended usage data, other data, or any combination thereof. These fundamental attributes may often be found on a product's safety data sheet (SDS), or by searching the Internet. For example, product information including fundamental attributes may be available from the manufacturer's website, an online database of products, a retailer's website, or any combination thereof. Once these fundamental attributes are determined, the attributes may be parsed and normalized for analysis in an algorithmic process.

The system 100 may use the extracted information to retrieve data about the product 102, including attributes. When the system 100 is unable to locate data about the product 102 in the database, the system 100 may launch an automated, real-time search for the product 102. In some implementations, the system 100 may launch web crawler applications and interact with one or more search engines based on the extracted information to identify the product 102, to obtain data about the product, or any combination thereof. In some implementations, the system 100 may determine information missing from one or more fields of a table or inconsistent information that cannot be resolved into canonical form by the computing system. The system 100 may process the product information and may determine that the product information is insufficient to automatically determine classifications (such as transportation classifications, hazard classifications, waste classifications, business logic classifications) and other information. The system 100 may provide an interface to a requester. The interface may be a webpage that may be rendered within an Internet browser application executing on a computing device associated with a requester. The interface may include the product information determined about the product as well as a detailed explanation regarding what pieces of information are missing. The interface may also include one or more user-accessible controls (such as buttons, text fields, pull-down menus, selectable links, other controls or any combination thereof). The interface may include prompts to guide the requester to supplement the product information.

In some implementations, instead of or in addition to sending the interface to the requester, the system 100 may automatically search one or more data sources to determine further information about the product 102. If the automated search fails, if the attributes determined from the search were determined to have a reliability that is below a threshold value, or if the system 100 determines that the product information is insufficient to determine the chemical properties or to perform automatic classifications, the system 100 may send at least a portion of the processed data 110 about the product 102 to a computing device associated with a user (a mechanical Turk 112), who may then search for information about the product 102. In some implementations, the system 100 may provide an interface including image data, barcode data, universal product code (UPC) data, other data, or any combination thereof to a computing device associated with the mechanical Turk 112. In such an example, the system 100 may generate or populate an interface with information indicative of the missing or unreliable information and one or more user-accessible controls and may provide the interface to a computing device associated with a mechanical Turk 112. The mechanical Turk 112 may be a user or operator who may or may not have training but who can extract and organize data extracted from the raw product data 106 and the processed data 110 and who can search one or more data sources for further information. The mechanical Turk 112 may be a relatively low-expertise (mechanical) human operator (e.g., an individual with search training) who may be engaged to facilitate data acquisition, when text parsing field or when there is insufficient information. The mechanical Turk 112 may search one or more data sources to identify information related to the product 102 and may supplement the parsed data with data retrieved from the one or more data sources.

The system 100 may combine the processed data 110, information from the mechanical Turk 112, other information (for example, data retrieved from one or more data sources based on the processed data 110 or the information from the mechanical Turk 112), or any combination thereof to produce a complete facet record 116. The complete facet record 116 may include chemical composition data, weight information, packaging data, other data, or any combination thereof.

The system 100 may process the complete facet record 116 via multiple paths. In a first path, the complete facet record 116 is used in conjunction with a classification calculator 118. The classification calculator 118 may include a plurality of deterministic calculations, which may be based on criteria presented in the United States Resource Conservation and Recovery Act (RCRA) definitions of federal hazardous waste. These criteria may be used, together with the chemical composition of the product 102, to determine one or more transportation classifications, one or more waste classifications, one or more hazard classifications, one or more business classifications, other data, or any combination thereof. In some implementations, the classification calculator 118 may utilize a plurality of Boolean expressions, chemical formula equations, rules, or combinations thereof to determine the regulatory classifications and to produce a classification calculator output. For example, the classification calculator 118 may execute one or more processes against the determined attributes to produce a plurality of classifications for the product. In order to determine how the product is classified per governmental regulations or a client's business rules, an extensive series of algorithms may be automatically applied to the attributes. In some implementations, the classification calculator 118 may determine regulatory and business logic classifications based on logical expressions (such as Boolean logic expressions), lookup tables, calculations, and synthetic intelligence (e.g., machine learning). The output of the series of algorithms includes a set of “First Principle” classifications. The regulatory classifications may pertain rules or guidelines for transportation of a product by land, air, or sea according to United States Department of Transportation regulations and optionally other transportation regulations, disposal of a product according to United States Environmental Protection Agency regulations and optionally other disposal rules and regulations; and so on. The business logic classifications may pertain to rules or guidelines for handling of a product by a retail employee, such as company rules for recycling of a product, donation of a product to a charity (i.e. reuse), emergency response to an incident involving a product, returning a product to vendor, packaging of a product, labeling of a product, or any combination thereof.

In parallel, the system 100 may provide the complete facet record 116 to a machine learning classification module 120 and a passthrough classification module 122. The machine learning classification module 120 may process the complete facet record 116 to use various algorithms and machine learning to determine regulatory classifications and to produce a machine learning classification output. The passthrough classification module 122 may provide the complete facet record 116 (including any regulatory data provided by a supplier, captured in the raw product data 106, provided by the mechanical Turk 112, or retrieved and integrated as part of the data aggregation product) to produce a passthrough classification output. Other implementations are also possible.

The system 100 may combine the classification calculator output, the machine learning classification output, and the passthrough classification output through an aggregation process 124 to produce a plurality of classification selections 126. Depending on the implementation, the plurality of classification selections 126 may include duplicate classifications. In some implementations, the system 100 may use the machine learning classification module 120 to remove duplicates and to resolve discrepancies to select regulatory classifications that accurately describe the produce 102 and to provide the classifications 128 as an output. The resulting output may include complete facet record data 116, determined classifications 126, other data, or any combination thereof.

In some implementations, the system 100 (the classification calculator 118 and the machine learning classification module 120) may determine confidence levels for each of the plurality of classifications. For example, the first principle classifications applied by the classification calculator 118 may be automatically subjected to an analysis of their respective confidence levels. In some implementations, algorithms, including synthetic intelligence algorithms (fuzzy logic, machine learning, neural networks, and so on), may be applied to assign a relative confidence score to each classification that has been generated. For example, confidence values may be determined within a range of 0 to 1, representing a percentage confidence or reliability. If a classification falls below a threshold score, the below-the-threshold classification will not be utilized in making client-facing recommendations without first verifying the classifications via a super Turk 134 or an expert Turk 136.

The classification selections 126 for the product 102 may be utilized to make business decisions. Once a product 102 has been classified (e.g., regulatory and business logic classifications have been determined), the classifications may be processed using another set of automated algorithms that address a specific task that the client is wishing to accomplish. The specific task may include disposal of a product 102, donation of a product 102, and so on. In some implementations, the output may include automated, optimized recommendations to the client. Some examples of specific client tasks for products may include, but are not limited to, transportation of the product by land, air, or sea; disposal of the product; recycling of the product; donation of the product to a charity (i.e. reuse); emergency response to an incident involving the product; return or the product to the vendor; packaging; labeling; other information; or any combination thereof.

In some implementations, such as when the system 100 is unable to determine which of the classifications 126 is correct or when the reliability value of the classifications is below a threshold level, the system 100 may provide an interface 132 including the classification selections 126, reliability data, product information, other data, or any combination thereof to a second-level operator (“super Turk”) 134, who may review, edit, confirm, reject, or even replace the classifications data. In some implementations, the second-level operator 134 may have insufficient experience or knowledge to complete the review or to edit the classifications. In such an example, the system 100 or the second-level operator 134 may forward or otherwise provide the interface including the classification selections 136 to a third-level operator (“expert Turk”) 138 to review, edit, select, or optionally confirm the classifications data. Other implementations are also possible.

Once the classifications data are confirmed, the system 100 may provide the selected classifications 128 as an output. The output may be provided to one or more data stores, including a database associated with the system 100 as well as data stores associated with other computing devices, such as sorting systems at various locations. At 130, the system 100 may synchronize the classifications data output with databases and in-field systems. Such synchronization may be performed periodically, such as monthly, weekly, daily, or on another schedule. Alternatively, synchronization may be triggered by any update to the database of the system 100, making new information available to related systems immediately. Other implementations are also possible.

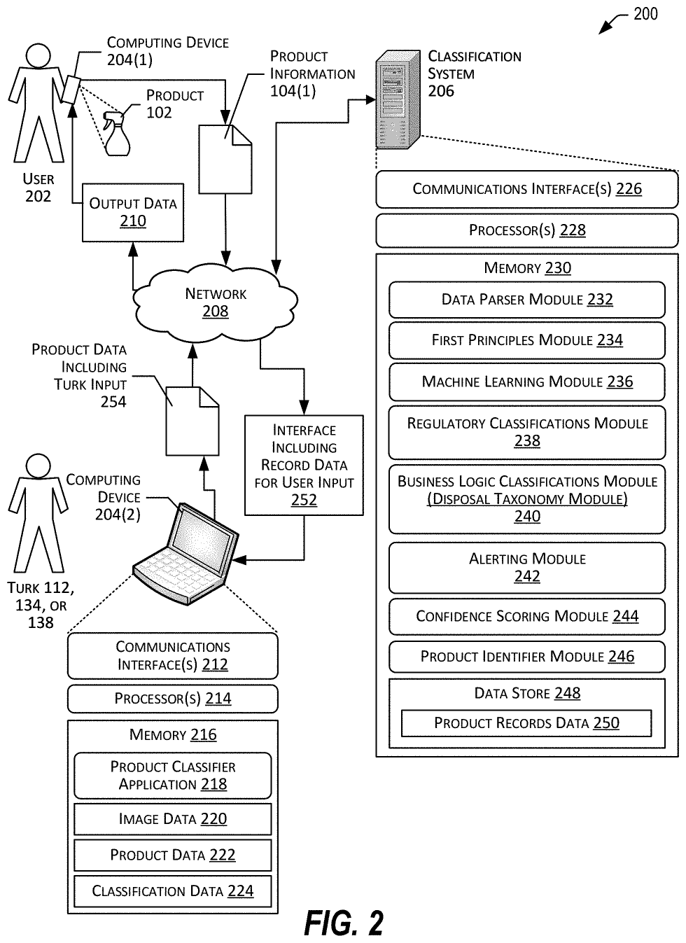

In some implementations, the output from the system 100 may include regulatory classification data (transportation data, waste disposal data, hazard data, etc.), business decision data (or recommendations) based on the regulatory classifications as well as information specific to an enterprise. In some implementations, the business decision data may include business logic classifications including rules or guidelines for the business with respect to products having certain regulatory classifications. For example, business rules or guidelines may allow for donation of a commercially available product (such as a disinfectant cleaner) to a particular entity, such as a food kitchen, or other business and may include a recommendation with respect to such donations. One possible example of such a system is described below with respect to FIG. 2.

FIG. 2 depicts a system 200 of classifying a product, in accordance with certain embodiments of the present disclosure. The system 200 may provide a computerized process by which a user 202 may enter information about a product 102 into a computing device 204 and receive output data 210 about the product 102 indicating one or more of regulatory classification data, business classification data, other data, or any combination thereof. In the illustrated example, a user 202 may utilize a computing device 204, such as a smartphone or other portable computing device, to capture images, barcode data, or other information about the product 102 and to send the product information 104 about a product 102 to a classification system 206 through a network 208. The network 208 may include one or more networks, including local area networks or wide area networks. In some implementations, the network 208 may include or may be coupled to the Internet.

In response to receiving the product information 104, the classification system 206 may determine chemical composition data associated with the product 102 and may determine regulatory data associated with the product, such as transportation regulations, hazard codes, waste regulations, other regulatory data, other product data, or any combination thereof. The classification system 206 may provide output data 210 to the computing device 204 associated with the user 202. The output data 210 may include one or more of regulatory classification data, business classification data, other data, or any combination thereof.

The computing device 204 may include a laptop computer, a tablet computer, a smartphone, another computing device, or any combination thereof. The computing device 204 may include one or more communication interfaces 212 to facilitate communication between input/output devices (such as keypads, touchscreens, displays, speakers, microphones, and so on) and one or more processors 214 of the computing device 204. Further, the communication interfaces 212 may be configured to send data to and to receive data from the network 208.

The computing device 204 may also include one or more memory devices 216, such as hard disc drives, solid-state drives, cache memories, random access memory (RAM), read-only memory (ROM), and so on. The memory 216 may store data and processor-readable instructions. In this example, the memory 216 may include a product classifier application 218 that, when executed, may cause the processor 214 to receive data about a product 102 and to determine product information 104. In some implementations, the product classifier application 218 may prompt the user 202 to capture image data 220 associated with the product 102. The product classifier application 218 may search a local data store of product data 222 to determine whether the chemical composition and regulatory classification data 224 is already known with respect to the product 102. If the product 102 is not known, the computing device 204 may combine data collected about the product 102 with image data 220 to form the product information 104, which may be sent through the network 208 to the classification system 206. The classification system 206 may send the output data 210 to the computing device 204 associated with the user 202. The output data may include product data 222 and classification data 224, which may be stored in the memory 216.

The classification system 206 may include one or more computer servers coupled to the network 208 and configured to process data. In some implementations, the functionality of the classification system 206 may be distributed across a plurality of computing devices. For example, the classification system 206 may be implemented “in the cloud”, enabling data processing and classification functions across a plurality of devices.

The classification system 206 may include one or more communication interfaces 226, which may include input/output device interfaces, network interfaces, or any combination thereof. The communication interfaces 226 may facilitate communication between the classification system 206 and the network 208.

The classification system 206 may include one or more processors 228 to execute processor-readable instructions and may include one or more memory devices 230. The memory devices 230 may include hard disc drives, solid-state drives, cache memories, random access memory (RAM), read-only memory (ROM), and so on. In this example, the memory 230 may include a data parser module 232 that, when executed, may cause the processor 228 to receive the product information 104 and to extract, transform, and load data from the product information 104 into one or more tables or other data structures for further processing and analysis.

The memory 230 may include a first principles module 234 that, when executed, may cause the processor 228 to analyze the product information using logical expressions, lookup tables, calculations, and synthetic intelligence (e.g., machine learning) that may be made based upon the chemical composition of a product and other data, such as intended use, packaging type and dimensions, physical properties, and so on. The first principles module 234 may apply deterministic logical expressions, such as Boolean expressions, to determine regulatory classifications and optionally business logic classifications based on the chemical composition. In some implementations, the determined classification data may also include an associated reliability value. For deterministic calculations, the reliability value may be determined based, in part, on the certainty associated with the chemical composition.

The memory 230 may also include a machine learning module 236 that, when executed, may cause the processor 228 to analyze the product information and to make determinations regarding the product 102 based on the product information, the output of the first principles module 234, other data, or any combination thereof. The machine learning module 236 may be trained on training data sets and may be improved over time based on feedback, edits made by users (such as Turks 134, 138, or both), and so on. Other implementations are also possible.

The memory 230 may include a regulatory classifications module 238 that, when executed, may cause the processor 228 to determine one or more regulatory classifications or codes for the product 102, based on the chemical composition data. The regulatory classifications may pertain rules or guidelines for transportation of a product by land, air, or sea according to United States Department of Transportation regulations and optionally other transportation regulations, disposal of a product according to United States Environmental Protection Agency regulations and optionally other disposal rules and regulations; and so on. The business logic classifications may pertain to rules or guidelines for handling of a product by a retail employee, such as company rules for recycling of a product, donation of a product to a charity (i.e. reuse), emergency response to an incident involving a product, returning a product to vendor, packaging of a product, labeling of a product, or any combination thereof.

In some implementations, the memory 230 may include business logic classifications module 240 that, when executed, may cause the processor 228 to determine rules that are specific to a retail location and may include different rules for another retail location. For example, the business logic classifications module 240 may determine rules or guidelines for disposal of a product 102. For a first product 102, the rules or guidelines may indicate that the product 102 may be recycled, reused at the retail location, or donated to a third-party. In some implementations, the business logic classifications module 240 may include a disposal taxonomy module that may simplify waste sorting, storage, and profiling such as by identifying the product independent of or in addition to regulatory classifications. For a second product 102, the rules or guidelines may indicate that the product must be disposed of according to the regulatory classifications. The business logic classifications module 240 may also determine donation of a product to a charity, reuse of the product by an employee at the retail location, and so on. In some implementations, the business logic classifications module 240 may include steps for emergency response to an incident involving the product, steps for returning the product to a vendor, steps for packaging (or repackaging) of the product, steps for labeling of the product or packaging, other tasks, or any combination thereof.

The memory 230 may include an alerting module 242, and a confidence scoring module 244. In some implementations, the confidence scoring module 244 may determine a reliability value for one or more of the regulatory classifications, for one or more of the business logic classifications, for the chemical composition data, for other data, or any combination thereof. The alerting module 242 may cause the processor 228 to send a message, such as an email message, a text message, or another alert to computing device 204(2) of a user, such as a Turk 112, 134, or 138. In some implementations, the processor 228 may send an interface 252 including data related to the product 102. The interface 252 may include record data, classification data, and one or more controls accessible by the user (Turk 112, 134, or 138) for receiving user input. In some implementations, the alerting module 242 may cause the processor 228 to send classification data and other data for the user to review, edit, and optionally confirm. Other implementations are also possible.

The user may complete his or her review of the record data and may submit the product data including Turk input 254 to the classification system 206. The product information 104, the chemical composition data, the regulatory classification data, the business logic classifications, the Turk input 254, and other data may be stored in product data records 250 of a data store 248.

In some implementations, the classification system 206 may include a product identifier module 246 that, when executed, may cause the processor 228 to receive the product information 104 and to attempt to identify the product 102 based on the product information by the data store 248 or one or more other data sources. If the product identifier module 246 identifies the product 102 based on the product information 104 (such as barcode data, universal product code (UPC) data, other data, or any combination thereof), the classification system 206 may retrieve the product data from the data store 248 and may provide output data 210 to the computing device 204 of the user 202.

In operation, the classification system 206 may receive product information 104 from the computing device 204 of the user 202. The classification system 206 may process the received product information 104 and may determine that the product information 104 is insufficient to determine one or more of the chemical composition data, the regulatory classifications data, the business logic classifications data, recommendations, other data, or any combination thereof. In this instance, the alerting module 242 may send the output data 210 to the computing device 204 of the user 202. The output data 210 may include the chemical composition data, the regulatory classifications data, the business logic classifications data, recommendations, other data, or any combination thereof.

In some implementations, if the confidence score of one or more of the determined chemical composition, the regulatory classification, and the business logic classification is below a confidence threshold, the alerting module 242 may cause the processor 228 to send an interface 252 to the computing device 204(2) of a selected one of the Turks 134 or 138. The interface 252 may include product information, determined information, confidence scores, other data, or any combination thereof as well as one or more controls accessible to enable the user (Turk 134 or 138) to review and edit or confirm the various pieces of information. The Turk 134 or 138 may interact with the interface 252 and may submit the resulting product data including Turk input data 254 to the classification system 206. The classification system 206 may update the product data records 250 of the data store 248 and may send data related to the determined information as output data 210 to the computing device 204(1) of the user 202. Other implementations are also possible.

The classification system 206 is configured to automatically determine classification data based on the received product information 104. If the product information 104 is insufficient to perform automatic classifications, the system 206 may send an alert to a Turk 112 to determine further information. Otherwise, if the confidence value or reliability value of a classification is below a threshold value, the system 206 may send an alert to a Turk 134 or 138 to determine further information, to review the classification data, to edit the classification data, to determine other information, or any combination thereof. The alert may include product data, classification data, business logic data, other data, or any combination thereof. The alert may also include user-selectable controls, such as buttons, tabs, links, text fields, checkboxes, pull-down menus, other controls, or any combination thereof.

In some implementations, the classification system 206 may selectively engage one or more Turks 134 or 138 when the confidence values of one or more of the chemical composition data, the regulatory classification data, and the business logic classification data falls below a threshold value. In one implementation, the threshold value may be approximately 0.9. In another implementation, the threshold value may higher for the chemical composition data and the regulatory classification data than for the business logic classification data. Other implementations are also possible. The classification system 206 may combine automatic classification of product information with an alerting module 242 configured to engage different tiers of human operators (e.g., mechanical Turk 112, super Turk 134, or expert Turk 138). Other implementations are also possible.

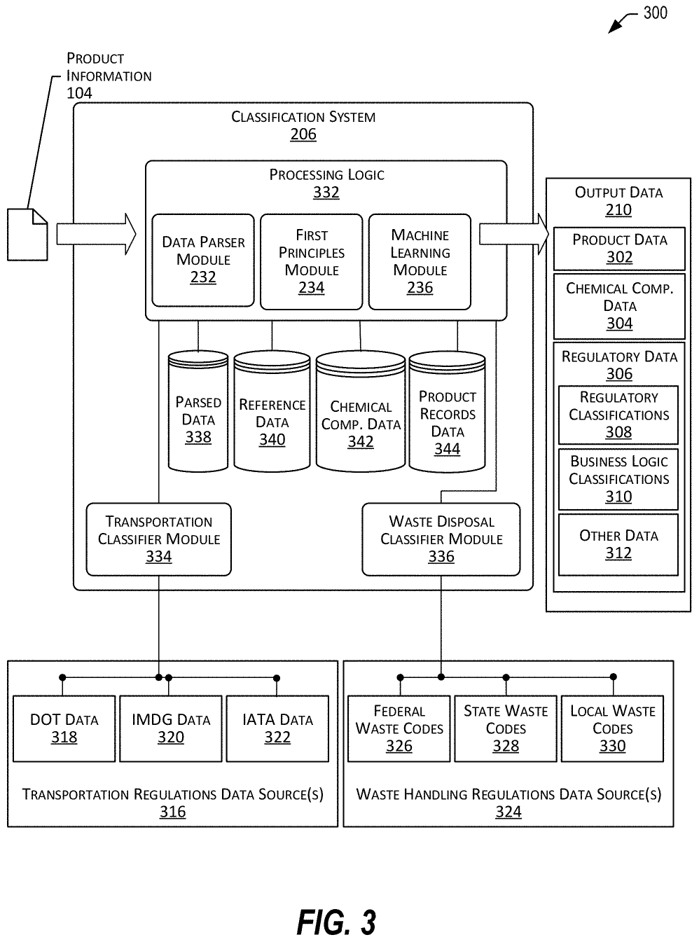

FIG. 3 depicts a system 300 including the classification system 206 to classify a product 102, in accordance with certain embodiments of the present disclosure. The classification system 206 may receive product information 104 from a computing device 204 associated with a requester (user 202) and may generate output data 210 based on the product information 104. The output data 210 may include the received product information 104, product data 302 determined via searches and calculations (including chemical composition data 304, regulator classifications data 306, business logic classification data 310), other data 312, and so on. In some implementations, the product information 104 may include a barcode, a universal product code (UPC), hazard class data, packing group data, United Nations (UN) numbers, proper shipping names (PSNs), other data, or any combination thereof. The product information 104 may include fundamental attributes including chemical properties, intended use, packaging type and dimensions, physical properties, and so on. In some implementations, the output data 210 may include chemical composition data 304 and regulatory data 306, including a collection of regulatory classifications 308 for the product that are generated per the rules of governmental, environmental, and transportation regulatory agencies. Examples of such regulatory classifications 308 may include federal waste codes, state waste codes, United Nations (UN) numbers, hazard classes, packaging groups, proper shipping names, limited quantity exceptions, other information, or any combination thereof. In an example, the regulatory classifications 308 may also include chemical composition data, chemical reactivity data, chemical corrosivity data, chemical toxicity data, flammability data, hazard data, transportation data, other data, or any combination thereof.

The regulatory data 306 may also include business logic classifications 310, which may be determined from the chemical composition data 304, from the regulatory classifications 308, and from the rules specified by a company. The rules specified by the company may include guidelines and procedures that are particular to the company. In an example, the regulatory data 306 may include first rules that are specific to a first retail location and second rules that are specific to a second retail location. Additionally, the first rules and the second rules may be different for different products 102. In another example, the business logic classifications 310 may include rules or guidelines for disposal of a product. For a first product, the rules or guidelines may indicate that the product may be recycled, reused at the retail location, or donated to a third-party. For a second product, the rules or guidelines may indicate that the product must be disposed of according to the regulatory classifications 308. The rules or guidelines may differ from business to business or from store to store within a larger business enterprise. The business logic classifications 310 may allow for donation of a product to a charity, reuse of the product by an employee at the retail location, and so on. Further, the business logic classifications 310 may include steps for emergency response to an incident involving the product, steps for returning the product to a vendor, steps for packaging (or repackaging) of the product, steps for labeling of the product or packaging, other tasks, or any combination thereof. The output data 210 may also include other data 312, such as location information, quantity information, and other data.

The classification system 206 may be configured to communicate with one or more external transportation regulation data sources 316. The one or more transportation regulations data sources 316 may include department of transportation (DOT) data 318 (Federal, state, and so on), International Maritime Dangerous Goods (IMDG) data 320, International Air Transport Association (IATA) data 322, other data, or any combination thereof.

The classification system 206 may also be configured to communicate with one or more external waste handling regulation data sources 324. The waste handling regulations data sources 324 may include federal waste codes 326 (such as Resource Conservation and Recovery Act rules and regulations promulgated and enforced by the EPA), state waste codes 328 (such as state laws and regulations promulgated by state legislatures and environmental agencies), local waste codes 330 (such as county and municipal waste rules and regulations), other codes or guidelines, or any combination thereof.

In some implementations, changes in regulatory data stored by the one or more transportation regulation data sources 316 or the waste handling regulation data sources 324 may trigger updates to the classification system 206. In an example, such changes may trigger the classification system 206 to generate an alert to an operator to review the changes. In some implementations, the classification system 206 may be configured to apply changes from the regulatory data to product records data stored within the system 206 to update existing records. In other implementations, the classification system 206 may validate the regulatory classifications data 306 based on the changes to the regulatory data when the classification system 206 retrieves the product records data 344 associated with the product information 104. Other implementations are also possible.

The classification system 206 may include processing logic 332 to receive the product information 104. The processing logic 332 may include a data parser module 232 configured to extract data from the product information 104 and to load the extracted data into a temporary table or database, such as parsed data 338. The processing logic 332 may further include a first principles module 234, which may access the parsed data 338 and reference data 340 and which may retrieve additional product data from one or more data sources based on the parsed data 338. The first principles module 234 may determine fundamental attributes of the product 102 based on the product information 104 and the retrieved additional product data. The fundamental attributes may include chemical composition data, which may be included in the product information 104 or which may be retrieved from chemical composition data 342, product records 344, from other data sources, or any combination thereof.

The first principles module 234 may use the one or more fundamental attributes to evaluate a plurality of logic expressions to determine multiple deterministic classifications. For example, the logic expressions may include Boolean logic expressions that may be used to determine the regulatory classifications deterministically. In an example, a Department of Transportation class 3 regulatory classification may be determined according to the following if-then statement:

IF (form=liquid) AND IF (Flashpoint<141° Fahrenheit (60.6° Celsius),

then DOT Hazard Classification=3 (Equation 1)

In another example, an environmental regulatory classification may be determined according to the following Boolean expression:

If [(form=liquid) AND (Flashpoint<140° F.)] OR (Hazard class=2.1) OR (Hazard class=4.1, 4.2, or 4.3) OR (Hazard class=5.1 or 5.2)

then EPA classification=RCRA D001 WASTE (Equation 2)

In still another example, an environmental regulatory classification may be determined according to the following expression:

If (Is aqueous) AND (form=liquid) AND (Concentration of H20>=50%) AND (pH<=2 OR pH>=12,5),

then EPA Classification=RCRA D002 WASTE (Equation 3)

Equations 1-3 above represent examples of logic expressions for determining a regulatory classification 308. Similar expressions may be used to evaluate options for handling of the product, such as donation, reuse, other business logic classifications data, and so on. In an example, a product may be reused at the retail location provided that the regulatory classifications do not include a specific waste classification or a specific hazard classification, and so on.

The regulatory classifications 308 may include a collection of classifications for the product that are generated based on the product information 104 per the rules of governmental, environmental, and transportation regulatory agencies. Examples of such classifications may include federal waste codes, state waste codes, United Nations (UN) numbers, hazard classes, packaging groups, proper shipping names, limited quantity exceptions, other information, or any combination thereof. In an example, the regulatory classifications 308 may be based, in part, on chemical composition data, and the first principles module 234 may use such data to determine chemical reactivity data, chemical corrosivity data, chemical toxicity data, flammability data, hazard data, transportation data, other data, or any combination thereof. In some implementations, the product information may also include a barcode, a universal product code (UPC), hazard class data, packing group data, United Nations (UN) numbers, proper shipping names (PSNs), other data, or any combination thereof.

The logic expressions may take various forms, including Boolean expressions, if-then statements, other types of conditional statements, calculations, comparisons, and so on. The logic expressions may be established from regulatory guidelines and may be formed to provide a deterministic classification based on the fundamental attributes of the product. The information used to evaluate the logic expressions may be determined from a safety data sheet (SDS) for the product 102, from information provided by a manufacturer or supplier, from third-party data sources, or any combination thereof.

In some implementations, the first principles module 234 may perform one or more calculations to determine additional information. The first principles module 234 may perform one or more lookups to the reference data 340, the parsed data 338, to other data sources, such as the transportation regulations data sources 316 or the waste handling regulation data sources 324, to other data sources, or any combination thereof. For example, the first principles module 234 may retrieve chemical composition data from one or more data sources based on the product information 104 or the parsed data 338.

The processing logic 332 may also include synthetic intelligence, such as a machine learning (ML) module 236. The machine learning module 236 may be configured to resolve ambiguities in lookup data, in various calculations, and so on. In one possible example, the machine learning module 236 may assign reliability values to one or more of the regulatory and business logic classifications. The machine learning module 236 may train using labeled data, training sets, other data, or any combination thereof. In some implementations, after the machine learning module 236 is trained, the machine learning module 236 may be able to resolve ambiguities and data discrepancies without involving a human operator. Other implementations are also possible.

In some implementations, the plurality of logic expressions of the first principles module 234 may include Boolean logic expressions, which may provide deterministic expressions for determining certain regulatory classifications based on the fundamental attributes. The Boolean logic expressions may include one or more logic operators, such as AND, OR, NOR, ANDNOT, and the like. In some implementations, the first principles module 234 may use computational algorithms based on fundamental chemical structure theory to estimate a wide variety of reactivity parameters based on the composition data, the fundamental attributes, and the molecular structure of the various components. The first principles module 234 provides chemical modeling of the composition and reactions of the components of the composition with water, air, and other components used to determine the reactivity. In an example, the reference data 340 may include a sequence of chemical reactions and formulas, which may be applied to the parsed data to determine reactivity data. Further, the reference data 340 may include reactivity determination data, toxicity determination data, corrosivity determination data, and flammability determination data, which may be used in conjunction with the parsed data 338 to determine toxicity values, corrosivity values, flammability values, and reactivity values. These values may be part of the regulatory classifications.

In the illustrated example, product information 104 related to a product (such as product 102 in FIG. 1 or FIG. 2) may be received. For example, a user 202 may access a computing device 204 to enter or provide product information 104 about the product 102 using a bar code reader, a camera, a keyboard, a microphone, other data input devices, or any combination thereof. In one possible example, the user 202 may utilize a computing device 204 to scan the barcodes of the product 102, enter product information 104 related to the product using a keyboard or other input device, capture image data of packaging of the product 102 using a camera of the computing device 204, or otherwise provide product-related information. In one possible example, an employee of a supplier or transporter of the product 102 may provide the product information 104.

Once the product information, the regulatory classifications, and the business logic classifications for the product 102 have been determined and stored in the product records data 344, the output data 210 may be provided to a computing device 204 associated with a user 202, such as the requester. For example, in response to receiving product information 104, the processing logic 332 may identify a match in the product records data 344, retrieve the information, and provide the output data 210 to a computing device 204. Other implementations are also possible.

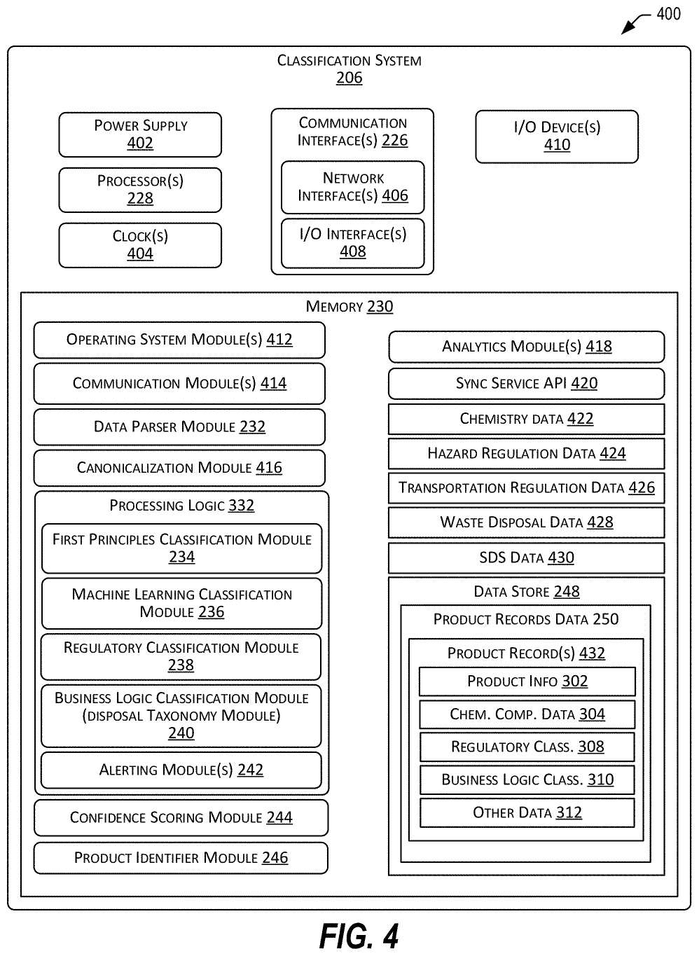

FIG. 4 depicts a diagram 400 of the classification system 206 of FIGS. 1-3, in accordance with certain embodiments of the present disclosure. The classification system 206 may include a power supply 402 to supply power to the various components. Further, the classification system 206 may include one or more processors 228, which may be configured to execute processor-executable instructions stored in the memory 230. The classification system 206 may further include one or more clocks 404 configured to provide ticks or timing signals, which may be used to timestamp data and optionally to drive operation of various components.

The classification system 206 may further include one or more communications interfaces 226. The one or more communications interfaces 226 may include one or more network interfaces 406. The one or more network interfaces 406 may include wired interfaces, such as an RJ-45 Ethernet port, or wireless interfaces, such as a Bluetooth transceiver, an IEEE 802.11x interface, other short-range wireless interfaces, long-range wireless interfaces (e.g., Wi-Fi, cellular network interfaces, and so on), other interfaces, or any combination thereof.

The one or more communications interfaces 226 may include one or more input/output (I/O) interfaces 408, which may communicate with I/O devices 410. The I/O devices 410 may include input devices, such as keyboards, touchscreens, microphones, scanners, pointer devices, cameras, removable storage devices (such as solid-state drives, thumb drives, and the like), barcode readers, other input devices, or any combination thereof. The I/O devices 410 may also include output devices, such as printers, displays, speakers, other devices, or any combination thereof. The I/O interfaces 408 may include a universal serial bus (USB) port, a high-definition multimedia interface (HDMI), other ports, other interfaces, or any combination thereof.

The classification system 206 may include one or more memories 230. The one or more memories 230 may include non-volatile memory devices, such as solid-state hard drives, hard disc drives, hybrid data storage devices, or any combination thereof. The one or more memories 230 may also include volatile memory devices, such as random-access memory (RAM), cache memory, other memory devices, or any combination thereof. The one or more memories 230 may store processor-executable instructions and may store data.

The memory 230 may include one or more operating system modules 412 that may control operation of the classification system 206. The memory 230 may further include one or more communication modules 414 that may control operation of the communication interfaces 226.

The memory 230 may include a data parser module 232 that, when executed, may cause the processor 228 to extract data from the product information 104 and to transform and load the extracted data into one or more temporary tables for further processing. The data parser module 232 may extract data from the product information 104 received from the computing device 204, from the information retrieved from one or more data sources, and so on. The data parser module 232 may provide the extracted data to the canonicalization module 416 to normalize the data into a pre-determined format and may then organize the extracted data into one or more categories of information, a temporary table, or another data structure.

The memory 230 may include a canonicalization module 416 to normalize extracted data. The canonicalization module 416 may cause the processor 228 to determine a normalized spelling for various terms and optionally to edit data in the one or more temporary tables to provide a consistent input. The memory 230 may also include a product identifier module 246, an alerting module 242, and processing logic 332. The product identifier module 246 may be configured to determine, from one or more data sources, information about the product 102 based on the product information 104. In some implementations, the product identifier module 246 may determine a barcode, a universal product code (UPC), or other identifier information from the product information, and may use the identifier to retrieve data about the product. Other implementations are also possible.

The memory 230 may also include processing logic 332, which may be implemented in software. In an alternative implementation, the processing logic 332 may be implemented in circuitry. In this implementation, the processing logic 332 may include a first principles classification module 234, which apply a plurality of logic expressions, one or more calculations, one or more lookups, or any combination thereof to determine regulatory classifications 308 and business logic classifications 310.

The processing logic 332 may further include a machine learning module 236 that may cause the processor 228 to evaluate the regulatory classifications 308 and the business logic classifications 310. In some implementations, the machine learning classification module 236 may be configured to automatically evaluate various classifications. Over time, the machine learning classification module 236 may be trained to resolve discrepancies in the data and to determine various aspects that may be more important than other aspects. Other implementations are also possible.

The processing logic 332 may include the alerting module 242, which may generate one or more messages, or which may provide interfaces to a computing device 204 through a network 208. In some implementations, the processing logic 332 may determine that the received product information 104 is insufficient to determine the chemical composition data 304, the regulatory classifications 308, the business logic classifications 310, or any combination thereof, and may cause the alerting module 242 to provide an interface including data indicative of information needed to make such determinations to a computing device 204 associated with one or more of the user 202 who submitted the product information 104 or another user (such as a user or Turk 112). The user 202 or the Turk 112 may supply further information in response to the interface and the processing logic 332 may evaluate the further information. If more information is still needed, the processing logic 332 may cause the alerting module 242 to provide a second interface including data indicative of the information needed. Otherwise, the processing logic 332 may operate on the product information 104 to determine the chemical composition data 304, the regulatory classifications 308, the business logic classifications 310, or any combination thereof.

The memory 230 may also include a confidence scoring module 244. The confidence scoring module 244 may determine reliability values for each calculated value, for each regulatory classification 308, and for each business logic classification 310. In some implementations, the confidence scoring module 244 may provide a confidence value or reliability value for each data item. If the confidence scores determined by the confidence scoring module 244 for a particular data item is below a threshold value, the alerting module 242 may provide an interface including data and one or more controls to a computing device 204 associated with a selected user (Turk) 134 or 138. The user may be a hazard classification expert who may interact with the one or more controls to review, edit, and optionally confirm one or more of the chemical composition data 304, the regulatory classifications 308, or the business logic classifications 310.

The memory 230 may include one or more analytics modules 418, which may process the chemical composition data 304, the regulatory classifications 308, the business logic classifications 310, product data 302, other data 312, or any combination thereof. In some implementations, the analytics module 418 may process the determined chemical composition data 304 and the regulatory classification data 308 for a product 102 relative to an existing safety data sheet (SDS) information for the product 102 from SDS data 430. The analytics module 418 may determine discrepancies between the SDS data 430 and the determined data. The memory 230 may also include other modules, such as a synchronization service application programming interface (API) 420. The API 420 may be accessed by client-facing devices, such as smartphones, laptop computers, tablet computers, single-item sorting devices, and the like. Such devices may send product information 104 to the API 420 and, in response thereto, may receive classification data, disposal taxonomy data, business classifications, other data, or any combination thereof. The memory 230 may also include other modules.

The memory 230 may also include chemistry data 422, such chemical properties and reaction information. The memory 230 may also include hazard regulation data 424, transportation regulation data 426, waste disposal data 428, and SDS data 430. The memory 230 may also include a data store 248.

The data store 248 may also store product data records 250. The data store 248 may include product information 302, regulatory classifications 308, business logic classifications 310, and other data 312.

In some implementations, the classification system 206 may be configured to receive product information 104 associated with a product 102. The classification system 206 may automatically process the product information 104, may retrieve additional product data, and may use the first principles classification module 234 to determine the chemical composition data 304. The classification system 206 may also use the regulatory classification module 238 to automatically determine regulatory classifications 308 and the business logic classification module 240 to automatically determine business logic classifications 310 associated with the product 102. In some implementations, the business logic classifications module 240 may include a disposal taxonomy module that may simplify waste sorting, storage, and profiling such as by identifying the product independent of or in addition to regulatory classifications. Other implementations are also possible.

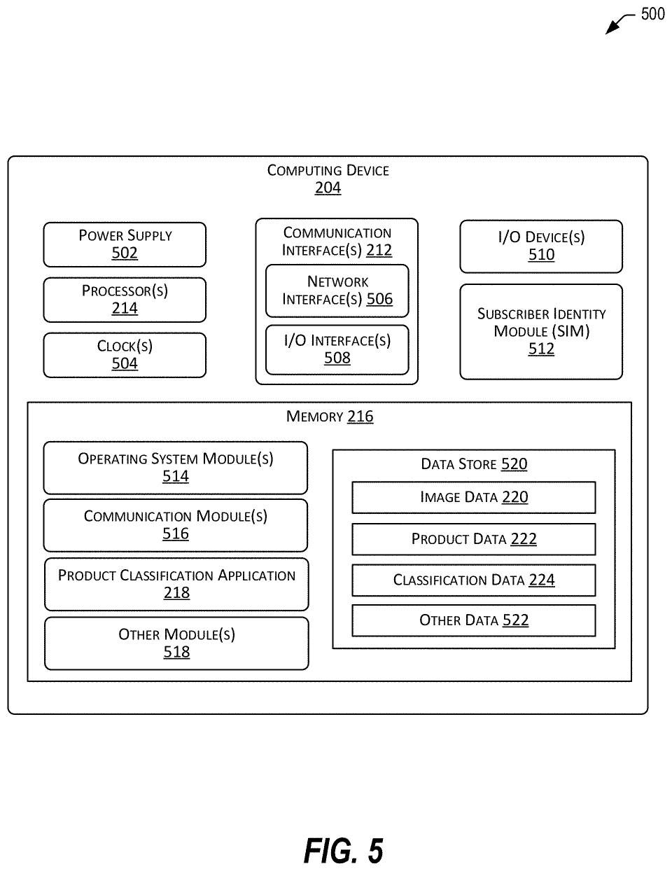

FIG. 5 depicts an embodiment 500 of a computing device 204 that may be used with the classification systems of FIGS. 1-4, in accordance with certain embodiments of the present disclosure. The computing device 204 may be a laptop computer, a tablet computer, a desktop computer, a smartphone, another computing device, or any combination thereof.

The computing device 204 may include a power supply 502, such as a battery, a transformer to couple the computing device 204 to plug or wall socket, or another power supply. The power supply 502 may provide power to the components of the computing device 204 via a power bus.

The computing device 204 may include one or more processors 214 configured to execute processor-readable instructions. The one or more processors 214 may load and execute instructions from a memory 216 of the computing device 204. The computing device 204 may include one or more clocks 504 to provide timing signals or ticks, which may be used by the processor 214 and by other components of the computing device 204.

The computing device 204 may include one or more communication interfaces 212. The communication interfaces 212 may include one or more network interfaces 506. The network interfaces 506 may enable communication between the computing device 204 and one or more networks 208. The networks 208 may include short-range networks (e.g., local area networks, Bluetooth®, and/or other networks), or long-range networks (e.g., wide area networks, cellular communication networks, and so on). In some implementations, the network 208 may include the Internet.

The communication interfaces may include input/output (I/O) interfaces 508, which may couple the computing device 204 to one or more I/O devices 510. The I/O interfaces 508 may include wired interfaces, such as universal serial bus (USB), Firewire, or other wired interfaces, as well as wireless interfaces, such as a Bluetooth® transceiver. The I/O devices 510 may include input devices, such as a keyboard, a barcode reader, a pointer device, a microphone, a scanner, a camera, another input device, or any combination thereof. The I/O devices 510 may include output devices, such as a display, a speaker, a printer, another output device, or any combination thereof. In some implementations, the I/O device 510 may combine input and output functionality, such as a touchscreen display. Other implementations are also possible.

The computing device 204 may include a subscriber identity module (SIM) 512, which may contain unique information that identifies the SIM 512 to a mobile network. The SIM 512 may be a small card that includes a chip that is removable and transferrable between phones. The SIM 512 stores information that uniquely identifies the user, enabling connection to the mobile network.

The computing device 204 may include one or more memories 216, such as hard disc drives, solid-state drives, cache memory, random access memory (RAM), read only memory (ROM), other memory devices, or any combination thereof. The memory 216 may store processor-readable instructions and may store data. The memory 216 may include one or more operating system (OS) modules 514, which may control operation of the computing device 204. The memory 216 may also include one or more communication modules 516 that may control operation of the communication interfaces 212.

The memory 216 may include a product classification application 218 that, when executed, may cause the processor 214 to receive information about a product 102. The information may be received from a scanner, a keypad, a camera, or another input device of the I/O devices 510, from another computing device via one of the network interfaces, from another source, or any combination thereof. The product classification application 218 may receive product information 104, parse the product information 104 into one or more temporary tables, and search product data 222 within a data store 520 within the memory 216 based on the product information 104. If the product information 104 is present in the product data 222, the classification data 224, or any combination thereof, the product classification application 218 may provide data to a display indicative of the product 102.

The memory 216 may also store other modules 518, which may be executed by the processor 214 to perform other functions. The memory 216 includes a data store 520 that may store image data 220, product data 222, classification data 224, and other data 522. When the product classification application 216 determines that a product 102 is already identified within the product data 522, the product classification application 216 may retrieve the data from the data store 520 and may provide a graphical interface including image data 220, product data 222, classification data 224, other data 522, or any combination thereof to an output device of the I/O devices 510, such as a display.

In an example, the computing device 204 may be a portable device, such as a smartphone or a hand-held computing device that may be used by a store employee, for example, to scan a product 102 with damaged packaging. The computing device 204 may capture image data (such as a barcode) of the product 102, search its data store 520, and provide a graphical interface including one or more classifications (regulatory, business, or both), one or more recommendations, and other data associated with the product 102 based on the retrieved information. For example, the user may access the product classification application 218 on the computing device 204 and may utilize an input device of the I/O devices 510 (such as a camera or keypad of the computing device 204) to enter information about a product 102. In response to receiving the information, the product classification application 218 may search the data store 520 to identify a match. If a match is found the product classification application 218 may provide an interface including one or more classifications (regulatory, business, or both), one or more recommendations with respect to handling or disposal of the product, and other data associated with the product 102 based on the retrieved information. If the product classification application 218 is unable to identify a match, the computing device 204 may send the product information 104 to the classification system 206. In response to sending the product information, the computing device 204 may receive product data 210 from the classification system 206. Other implementations are also possible.

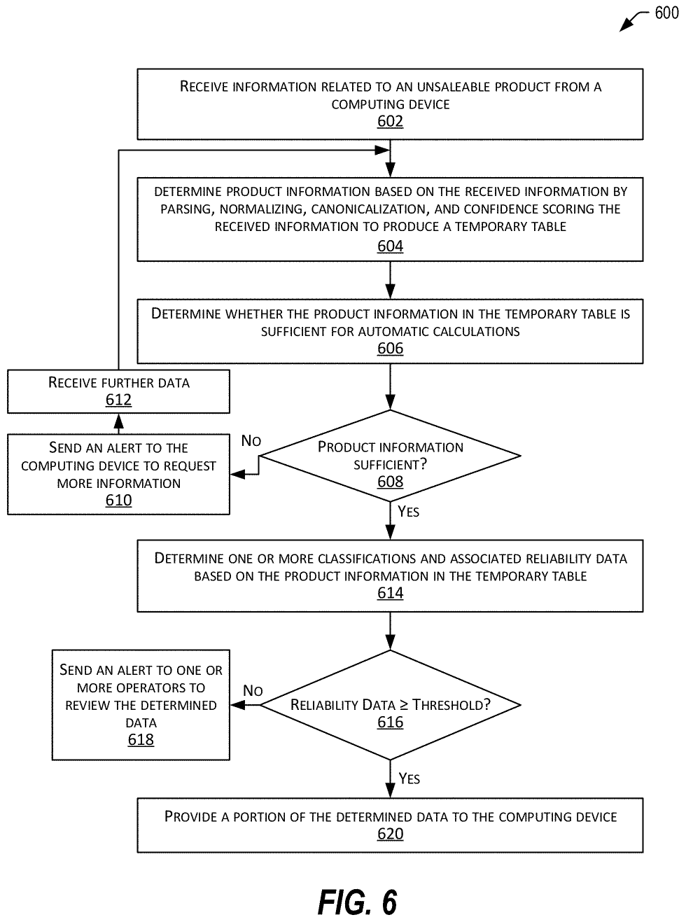

FIG. 6 depicts a flow diagram of a method 600 of determining a classification of a product using automated systems and human operators, in accordance with certain embodiments of the present disclosure. At 602, the method 600 may include receiving information related to an unsaleable product from a computing device. The information may be received from a webform submitted by a user 202 using a computing device 204 or may be received from another computing system. For example, the classification system 206 may receive product information 104 related to an unsaleable product from a computing system of a product retailer, a wholesaler, or other source. The unsaleable product may have damaged packaging, may have been returned, and so on.

At 604, the method 600 may include determining product information based on the received information by parsing, normalizing, canonicalization, and scoring the received information to produce a temporary table. In some implementations, the classification system 206 may apply optical carriage recognition to an image of the labeling or packaging of the product 102 to determine text and may organize the determined text into one or more fields or cells of a temporary table. Further, the product information may include text submitted by the user, as well as barcode data and other data. The classification system 206 may process the text, barcode data, and other data into the temporary table.

In some implementations, the classification system 206 may search one or more data sources based on the received data to determine further information about the product 102. Such further information may include SDS data, chemical composition information, or other information, all of which may be parsed, normalized, canonicalized, and scored by the classification system 206 and included in the temporary table.

At 606, the method 600 may include determining whether the product information in the temporary table is sufficient for automatic calculations 606. For example, certain chemical properties may be determinative of classifications, while other chemical properties may require additional information to determine their stability and their appropriate classification. Further, in some implementations, a product identifier or a picture of the product packaging may provide insufficient information to determine the sufficiency of the product information. In some implementations, the product information may be sufficient if a product record can be determined from one or more data sources that matches the product information. The product record may include previously determined classifications, chemical composition data, other data, or any combination thereof. The sufficiency of the product information may be determined based on retrieval of a data record from memory that matches the product information.

At 608, if the product information in the temporary table is not sufficient, the method 600 may send an alert to the computing device of the requester to request more information, at 610. The alert may include an interface that may be rendered within an Internet browser window. The interface may include information about the product 102 and one or more fields or selectable controls to prompt the user 202 to enter further information. In some implementations, the alert may include one or more prompts to the guide the user 202 to provide further information about the product 102. Other implementations are also possible.

At 612, the method 600 may include receiving further data, at 612. The further data may include chemical data or other data that was missing from the originally received information. The method 600 may then return to 604 to determine the product information based on the received information.

Otherwise, at 608, if the product information is sufficient, the method 600 may include determining one or more classifications and associated reliability data based on the product information in the temporary table, at 614. In some implementations, the classifications may be determined based on one or more of deterministic calculations, logic expressions, chemical reaction calculations, other information, other determinations, or any combination thereof. Each determination or calculation may include an associated reliability score or value based on the strength of the data in the temporary table and based, in part, on other information. For example, if the product classification was previously reviewed and validated by an expert user, the information may be given more weight than if the information is inferred from one or more data points. Additionally, if a determination is made based on a deterministic logic expression (such as a Boolean expression), the determination may be given greater weight than if the classification were calculated based only on a chemical reaction table or equation. Some determinations may be inherently more reliable than others, and the reliability score may be relatively higher for such determinations. Other implementations are also possible.

At 616, if the reliability of the classifications and other information is less than a threshold value, the method 600 may include sending an alert to one or more operators to review the determined data, at 618. The alert may include an interface that may be rendered within an Internet browser application or within another application running on a computing device 204 associated with one or more of the super Turk 134 or the expert Turk 138. The interface may include product information, image data, text data, and user-accessible controls that may be accessed by the super Turk 134 or the expert Turk 138 to review and optionally edit, confirm, or even reject the classifications data and other data. If the classification data is rejected by super Turk 134 or the expert Turk 138, the classification system 206 may send an alert to the user 202 to request further information. Other implementations are also possible.

It should be appreciated that some classifications may be more important than others, in part, because the risk is greater when the classification is wrong. In an example, a hazard classification may have a first reliability value that is compared to a first reliability threshold, while a business logic classification may have a second reliability value that is compared to a second reliability threshold, which may be lower than the first reliability threshold.

At 616, if the reliability is greater than or equal to a threshold, the method 600 may include providing a portion of the determined data to the computing device 204 of the user 202, at 620. In an example, the classification system 206 may provide an interface including data identifying the product 102 and including classification data, such as regulatory classifications (hazard classifications, waste classifications, transportation classifications, business classifications, other classifications, or any combination thereof. The interface may also include weight data, chemical composition data, other data, or any combination thereof. Further, the classifications and determined reliability data may be stored in a data store for subsequent retrieval and use.

In some implementations, the classification system 206 may determine that the one or more classifications and their associated reliability data are below the threshold and may select a classification that is more restrictive than the determined classification for the product 102. In another implementation, the classification system 206 may provide one or more classifications to the super Turk 134 or the expert Turk 138 for selection. In an example, the classification system 206 may determine classification selections 126, which may be determined by the classification calculator 118, the machine learning classification module 120, or may be part of the product data 104 and provided as part of a passthrough classification module 122. The classification system 206 may provide an interface including text data, image data, classification selections 126, audio data, other data, selectable controls, or any combination thereof to a computing device 204 associated with the super Turk 134, the expert Turk 138, or both. In response to selection of one or more of the selectable controls, the classification system 206 may assign one or more classifications to the product 102. Other implementations are also possible.

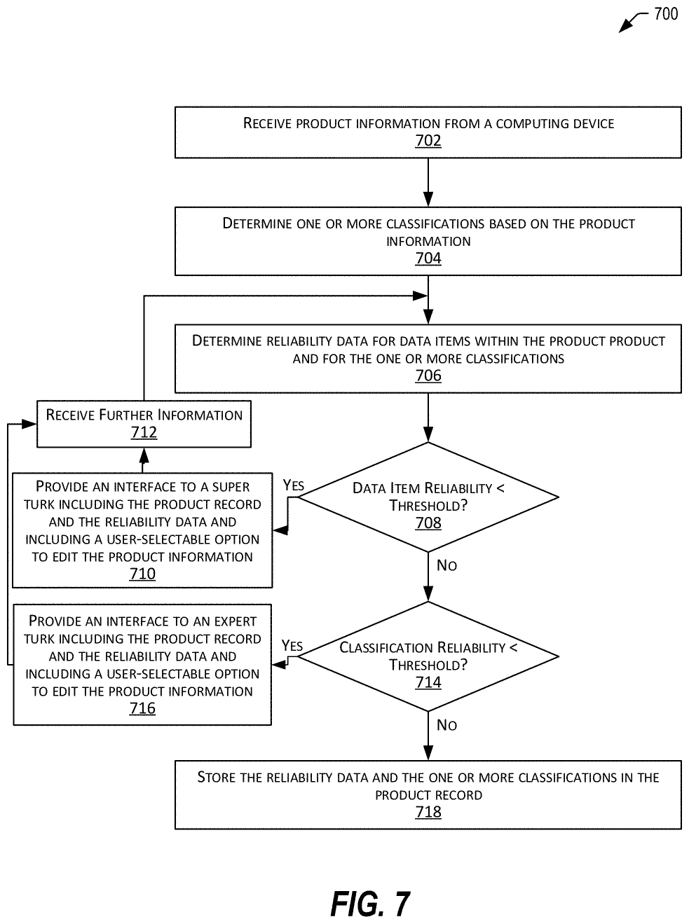

FIG. 7 depicts a flow diagram of a method 700 of determining a classification of a product using automated systems and human operators, in accordance with certain embodiments of the present disclosure. At 702, the method 700 may include receiving product information from a computing device. In some implementations, the computing device may be a smartphone, a laptop computer, a tablet computer, or another computing device associated with a user 202. In other implementations, the computing device may be computer server associated with the classification system 206 or another system. The product information may include chemical composition data, image data, barcode data, product name data, other data, or any combination thereof.

At 704, the method 700 may include determining one or more classifications based on the product information. The classifications may include regulatory classifications (such as hazard classifications, waste classifications, transportation classifications, other classifications, or any combination thereof), business classifications, other data, or any combination thereof. In some implementations, the classification system 206 may determine the regulatory classifications and the business classifications using one or more algorithms, Boolean expressions, logical formulas, chemical reactivity equations, and so on. Other implementations are also possible.

At 706, the method 700 may include determining reliability data for data items within the product record and for the one or more classifications. The reliability data may be determined based on various factors. In one example, the reliability of the chemical composition data may rise to 100% when the input data matches already verified data within the classification system 206. In another example, the reliability data may be dependent on the type of expression used to determine the classification or value. For example, if the expression was a Boolean expression, the resulting value may have a higher reliability value than if the expression relied upon a sequence of calculations that use operands or values from other expressions. Other implementations are also possible.

In another example, when the composition data is based on data input by a user 202 and the composition data cannot be verified automatically from matching data already stored in the data store, the classification system 206 may automatically reduce the reliability score to trigger a review by a super Turk 134 or an expert Turk 138. For example, if the reliability threshold is 0.97, then the first time the composition data is received for a product 102, the classification system 206 may deduct 0.10 to ensure that the classifications are reviewed.

At 708, if the reliabilities of the data items are below a threshold reliability value, the method 700 may include providing an interface to a super Turk 134 including the product record and the reliability data and including a user-selectable option to edit the product record, at 710. The interface may be rendered within an Internet browser application or may include data that may be rendered by another application executing on the computing device. The interface may include data and one or more controls accessible by the super Turk 134 (or an expert Turk 138) to review the product information, the classification data, and the reliability data and to edit, reject, or approve data items associated with the product information. Other implementations are also possible.

The super Turk 134 or the expert Turk 138 may interact with the interface to provide further information, to edit the chemical composition data or the product data, and so on. The super Turk 134 or the expert Turk may select one or more controls of the interface and may select a “submit” control to send data from the super Turk 134 or the expert Turk 138. The system may receive further information, at 712 from the super Turk 134 or the expert Turk 138, and the method 700 may return to 706 to determine reliability data for the data items within the product information (including the information provided by the super Turk 134 or expert Turk 138).

Returning to 708, if the reliability data for the data items are greater than or equal to the threshold, the method 700 may include determining if the classification reliability is less than a threshold, at 714. If yes, the method 700 may include providing an interface to an expert Turk 138 including the product information, the classification data, and reliability data and including one or more user-selectable options to review and optionally edit the product information, at 716. The interface may be rendered within an Internet browser application or may include data that may otherwise be rendered within an application executing on a computing device associated with the expert Turk 138. The interface may include data and one or more controls accessible by the expert Turk 138 to review the classifications and reliability data and to edit, reject, or approve the classifications. Other implementations are also possible.

The super Turk 134 or the expert Turk 138 may interact with the interface to provide further information, to edit the chemical composition data or the product data, and so on. The super Turk 134 or the expert Turk 138 may select one or more controls of the interface and may select a “submit” control to send data from the super Turk 134 or the expert Turk 138. In response, the system may receive further information, at 712, which may be used to determine reliability data, at 706.

Otherwise, at 714, if the classification reliability is greater than or equal to a threshold value, the method 700 may include storing the reliability data and the one or more classifications in the product record, at 718. In an example, the reliability data and the classifications may be stored in a data store of a classification system 206. In some implementations, the reliability data, the regulatory classifications data, and other data may be communicated to a computing device 204 associated with user 202. Other implementations are also possible.

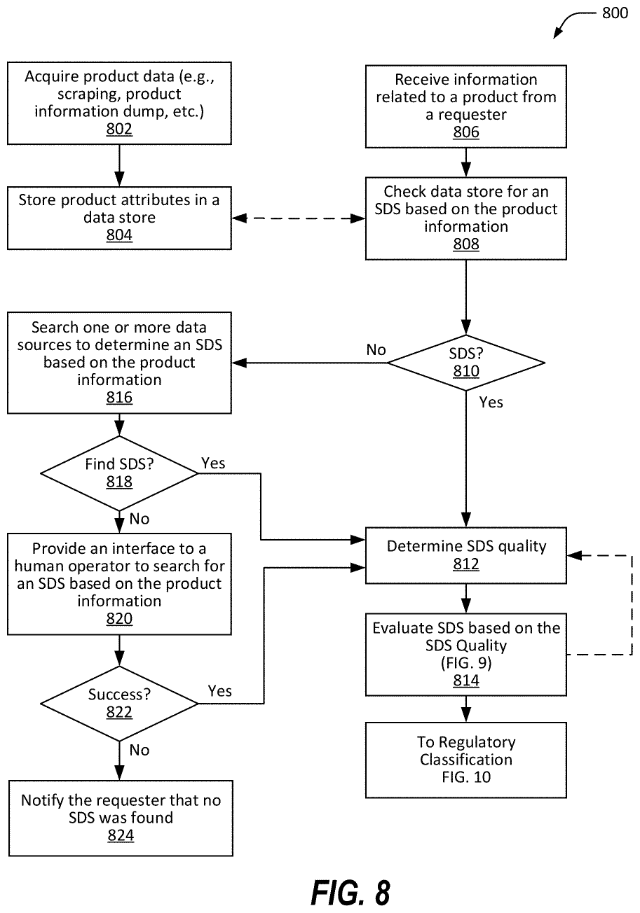

FIG. 8 depicts a flow diagram of a method 800 of acquiring data for the classification system, in accordance with certain embodiments of the present disclosure. With respect to the method 800, the system may acquire data in a variety of ways, including manual data entry, website scraping, product data importation, and so on.

At 802, the method includes acquiring product data, such as by data scraping, product information dump, or another manner. In an example, an Internet bot or spider may crawl multiple data sources, scraping SDS data and other data from various data sources.

At 804, product attributes may be stored in a data store. The product attributes may be determined from the acquired product data. In some implementations, the system may automatically extract, transform, and load data from the acquired product data into temporary tables or into a pre-determined data structure. Over time or periodically, the data store may be updated to include product information including product attributes for a plurality of products.

At 806, the method 800 may include receiving information related to a product from a requester. The system may receive the information (e.g., product information 104) from a computing device (e.g., a smartphone, a tablet computer, a laptop computer, a single item sorting device, another computing device, or any combination thereof). In an example, a user may scan a barcode, capture an image of a product 102, enter data at a keyboard, provide audio data, provide other data, or any combination thereof and may send the data to the system.

At 808, the method 800 may search the data store for an SDS based on the product information. In an example, the system may utilize a product name, barcode data, image data, text data, or other data to identify an SDS associated with the product information.

At 810, if the SDS is retrieved, the method 800 may include determining a quality of the SDS, at 812. The quality of the SDS or the reliability value associated with the SDS may be determined based on several factors. In an example, the existence of multiple inconsistent SDS documents may result in a quality score indicative of the inconsistencies. In another example, missing data or data that differs from information determined about the product may cause the system to assign a quality value that is indicative of the missing or inconsistent data. In some implementations, the system may search multiple data sources and may retrieve multiple SDS forms, multiple product attributes, and so on.

At 814, the method 800 may include evaluating the SDS based on the SDS quality. The system may evaluate the SDS using a scoring engine or human operators, depending on the quality or reliability score. In some implementations, information from a human operator may be returned, and the method 800 may provide the information to 812 to determine the SDS quality. The SDS quality may be verified by aligning multiple “observations” or data attributes determined from multiple sources (including multiple SDS forms, multiple websites, multiple whitepapers, data provided by requester, data provided by a manufacturer, and so no). The SDS quality may be determined based on correspondence of the data from multiple sources. Discrepancies in the data (e.g., two different pH values, etc.) may cause the system to determine that the quality value is decreased.

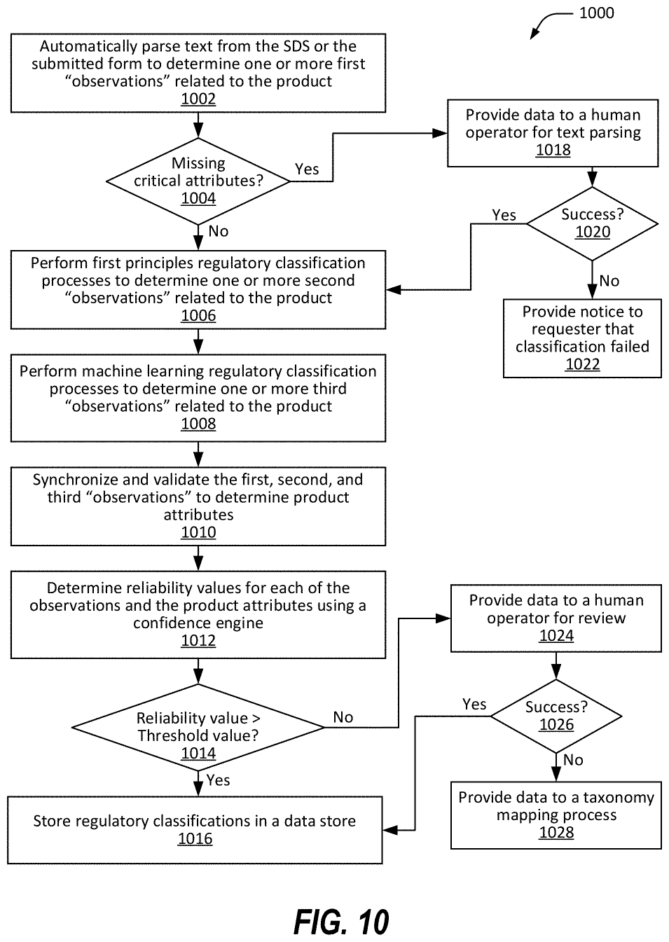

At 816, the method 800 may include providing the SDS to a regulatory classification process, which is described below with respect to FIG. 10.

Returning to 810, if the SDS is not retrieved, the method 800 may include searching one or more data sources to determine an SDS based on the product information, at 816. In an example, the system 206 may automatically search one or more databases, one or more websites, or other data sources to determine information about the product 102. Additionally, the system 206 may utilize search engines or data sources available over the Internet to identify the SDS and other product information.

At 818, if the SDS is found, the method 800 may determine the SDS quality, at 812. Otherwise, if the SDS is not found at 818, the method 800 may include providing an interface to a human operator to search for an SDS based on the product information, at 820. The interface may include the product information and may include prompts and controls to guide the human operator to perform a manual search. In other implementations, the system may provide data including the product information and instructions that may cause a processor of a computing device to render an interface including the data. Other implementations are also possible.

The human operator may interact with his or her computing device to perform a search for the SDS and may review retrieved data to identify retrieved data. Other implementations are also possible.

At 822, if the human operator is successful in retrieving the SDS data, the method 800 may include determining the SDS quality, at 812. Otherwise, the method 800 may include notifying the requester that no SDS was found, at 824. The notification may be in the form of an email or other electronic alert, which may include prompts indicative of the missing information.

The SDS data may provide the initial seed information that can be used to determine various regulatory and business classifications and to determine a disposal taxonomy for the product 102. Other implementations are also possible.

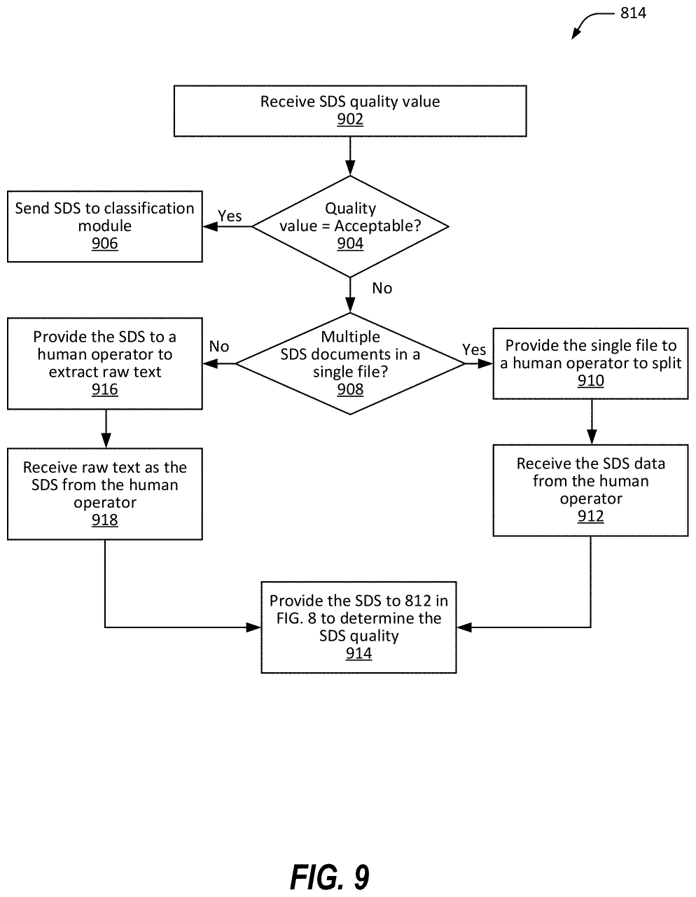

FIG. 9 depicts a flow diagram of a method of evaluating a quality level of safety data sheet (SDS), in accordance with certain embodiments of the present disclosure. The method depicted in FIG. 9 may represent block 814 in FIG. 8.

At 902, the method 814 may include receiving the SDS quality value. The quality value may be indicative of missing or inconsistent information included within one or more SDS forms associated with a product. The quality value may also be indicative of the source of the data or of data that can be verified based on matching product attributes retrieved from multiple data sources. Other implementations are also possible.

At 904, if the quality value is acceptable (e.g., has a quality value greater than a threshold value), the method 814 may include sending the SDS to a classification module, at 906. In this example, the system may determine that the identified SDS is of sufficient quality or accuracy that the SDS data may be relied upon for regulatory classification purposes.

Returning to 904, if the quality value is less than a threshold (not acceptable), the method 814 may include determining if multiple SDS documents are included in a single file, at 908. In an example, the system may combine SDS forms into a single document so that the different versions of the SDS data can be compared. If yes, the method 814 may include providing the single file to a human operator to split, at 910. In an example, the human operator may extract the data from a most recent version of the SDS for the product 102 and may provide the extracted data to the system 206. In some implementations, the human operator may compare data values in the different SDS forms to determine a reliability for each product attribute. Other implementations are also possible.

At 912, the method 814 may include receiving the SDS data from the human operator. The SDS data may include data extracted from one or more of the SDS documents. The human operator may send the SDS data to the system, such as by entering the data in a web-based form and submitting it.

At 914, the method 814 may include providing the SDS to block 812 in FIG. 8 to determine the SDS quality. In some implementations, the system 206 may determine quality based on data in particular data fields or the absence thereof, based on the reliability of the source of the product attribute, based on other data, or any combination thereof. The system 206 may also identify discrepancies between different versions of the SDS. Other quality metrics may also be used.

Returning to 908, if multiple SDS documents are not present, the method 814 may include providing the SDS to a human operator to extract raw data, at 916. The SDS may be provided within an interface that includes data and that includes one or more controls accessible by a human operator to review, edit, extract, and load text from the SDS into one or more fields. Alternatively, the system may send data and optionally formatting instructions that can be rendered within an application interface executing on a computing device associated with the human operator. The human operator may interact with one or more controls within an interface on his or her computing device to submit the data to the system.

At 918, the method 814 may include receiving raw text as the SDS from the human operator. The raw text may be received in the form of fields of a web-based form populated by the human operator interacting with the computing device and submitted by the human operator by accessing one or more control elements. The SDS may be provided to block 812 in FIG. 8 to determine the SDS quality, at 918.

The methods 800 and 814 in FIGS. 8 and 9 describe a process of acquiring and validating product information in the form of an SDS or other product information format, which may be used to perform an automated regulatory classification operation. An example of such a regulatory classification process is described with respect to FIG. 10 below.

FIG. 10 depicts a flow diagram of a method 1000 of determining one or more regulatory classifications, in accordance with certain embodiments of the present disclosure. At 1002, the method 1000 may include automatically parsing text from the SDS or from the submitted form to determine one or more first “observations” related to the product. The term “observation” refers to an instance of a data attribute (e.g., an extracted data attribute from a first source constitutes a first observation, while a data attribute from a second source constitutes a second observation). The system may extract SDS data and populate one or more temporary tables with the data.

At 1004, the method 1000 may include determining if the SDS data is missing critical attributes. Critical attributes may include chemical composition data, volume data, packaging data, other data, or any combination thereof, which critical attributes may be used in one or more logical, mathematical, or chemical expressions to determine a regulatory classification. An attribute may be deemed critical if its absence prevents the system from reliably determining a regulatory classification.

At 1004, if critical data is not missing, the method 1000 may include performing first principles regulatory classification processes to determine one or more second “observations” related to the product, at 1006. The first principles regulatory classification process may utilize Boolean expressions, logical relationships, calculations, other determinations, or any combination thereof to determine one or more product attributes. In some implementations, the output of the machine learning regulatory classifications may include hazard classifications, transportation classifications, waste disposal classifications, business logic classifications, and so on. Each determination may be considered one of the one or more second “observations”.

At 1008, the method 1000 may include performing machine learning regulatory classification processes to determine one or more third “observations” related to the product. The machine learning regulatory processes may include fuzzy logic, neural networks, or other machine-enabled decision-making systems. In some implementations, the output of the machine learning regulatory classifications may include hazard classifications, transportation classifications, waste disposal classifications, business logic classifications, and so on. Each determination may be considered one of the one or more third “observations”.

At 1010, the method 1000 may include synchronizing and validating the first, second, and third “observations” to determine product attributes. The system may synchronize the observations by organizing the data. Further, the system may validate the “observations” to make sure that they make sense. For example, a pH value of 400 would be outside of an expected range, and thus can be discounted or determined to be invalid.

At 1012, the method 1000 may include determining reliability values for each of the observations and the product attributes using a confidence engine. The reliability values may be determined by comparing the observations to determine consistency across multiple “observations”, determine discrepancies, and so on.

At 1014, if the reliability value is greater than a threshold value, the method 1000 may include storing the regulatory classifications in a data store, at 1016. The data store may be maintained in a memory that is part of the classification system 206 or may be stored in a third-party database that is accessible through a network.

Returning to 1004, if the data is missing critical attributes, the method 1000 may include providing the data to a human operator for text parsing, at 1018. The data may be provided within an interface or may provided to a computing device that may generator or render an interface including the data and one or more controls. The human operator may review the product attributes, to search for the missing product attributes, and optionally supplement the product attributes based on retrieved data.

At 1020, if the search and retrieval process was successful, the method 1000 may include performing first principles regulatory classification processes to determine one or more second “observations” related to the product, at 1006. Otherwise, at 1020, if the search and retrieval process was unsuccessful, the method 1000 may include providing notice to the requester that the classification failed, at 1022. The notice may be provided in the form of an electronic alert (text message, email, popup interface, and so on), which may be sent to a computing device associated with a requester (i.e., a person who submitted the product information to the classification system 206). Other implementations are also possible.

Returning to 1014, if the reliability value is less than or equal to the threshold value, the method 1000 may include providing data to a human operator for review, at 1024. The data may be provided as part of an application interface or may be sent with instructions that may cause a computing device to render the data within an interface that includes controls accessible by the human operator. The human operator may use the interface and interact with the controls to review, edit, and optionally confirm one or more classifications.

At 1026, if the review process is successful, the method 1000 may include storing the regulatory classifications in a data store, at 1016. Otherwise, if the review is not successful at 1026, the method 1000 may include providing the data to a taxonomy mapping process, at 1028. The taxonomy mapping process may be used to identify a characteristic of the product, such as what the product is (i.e., a battery), even if the system is not able to determine the regulatory classifications.

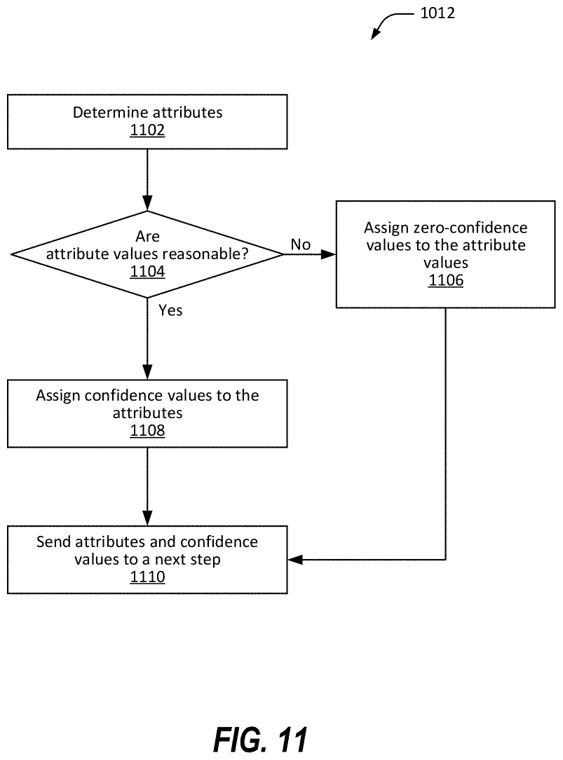

FIG. 11 depicts a flow diagram of a method 1012 of assigning confidence values for the one or more regulatory classifications), in accordance with certain embodiments of the present disclosure. At 1102, the method 1100 may include determining one or more attributes of the product. The attributes may be determined based on the method of FIG. 10, by retrieving data from the data store, from another source, or any combination thereof.

At 1104, the method 1100 may include processing the attributes of the product to determine if the attributes values are reasonable. For example, the attribute values may be evaluated against an expected range of values to determine whether the attribute value is within the expected range. If the attribute value is outside of the range, the value may be unreasonable and may be discarded or determined to be in error.

At 1104, if the attributes are not reasonable, the method 1100 may include assigning zero-confidence values to the attribute values, at 1106. In this example, by assigning zero-confidence values to the attributes, the product attributes are treated as being unreliable for the purpose of determining regulatory classifications.

At 1110, the method 1100 may include sending the attributes and confidence values to a next step. The next step may include storing the classifications and other data in a data store. Alternatively, the next step may include further include processing the attributes and confidence values, displaying data related to the attributes, or other actions. Other implementations are also possible.

Returning to 1104, if the attribute values are reasonable, the method 1100 may include assigning confidence values to the attributes, at 1108. The confidence values may be automatically assigned by a confidence engine or by another module based, at least in part, on the consistency of the data. At 1110, the attributes and confidence values may be provided to a next step in the process.

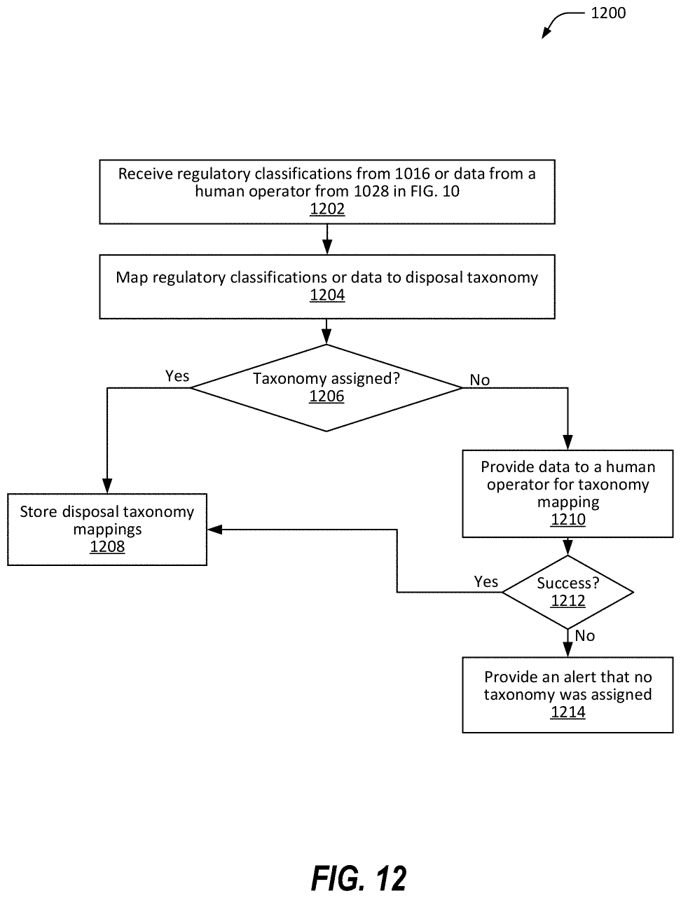

FIG. 12 depicts a flow diagram of a method 1200 of determining disposal taxonomy mappings based on the product information or the regulatory classifications), in accordance with certain embodiments of the present disclosure. At 1202, the method 1200 may include receiving regulatory classifications from block 1016 or from a human operator from block 1028 in FIG. 10. In some implementations, the regulatory classifications may be retrieved from the data store or received from another source.

At 1204, the method 1200 may include mapping regulatory classifications or the data from the human operator to a disposal taxonomy. The disposal taxonomy may include identification of the product, independent of the regulatory classifications, such as by identifying the product by type (e.g., Lithium Ion Battery). Other implementations are also possible.

At 1206, if the taxonomy is assigned, the method 1200 may include storing the disposal taxonomy mappings, at 1208. The disposal taxonomy mappings may be stored in a data store or a database.

Returning to 1206, if the taxonomy is not assigned to the product, the method 1200 may include providing data to a human operator for taxonomy mapping, at 1210. The human operator may review the data and identify the product. In one example, the system may provide an interface including the data and including one or more controls, such as pull-down menus or other controls, from which the human operator may select an appropriate mapping. Alternatively, if there is no existing mapping, the interface may provide a control option to create a new mapping. Other implementations are also possible.

At 1212, if the mapping by the human operator is successful, the method 1200 may include storing the disposal taxonomy mappings, at 1208. Otherwise, the method 1200 may include providing an alert that no taxonomy was assigned, at 1214. In an example, the alert may include an electronic message (text, email, popup interface, etc.), which may be sent to a human operator, such as an administrator. Other implementations are also possible.

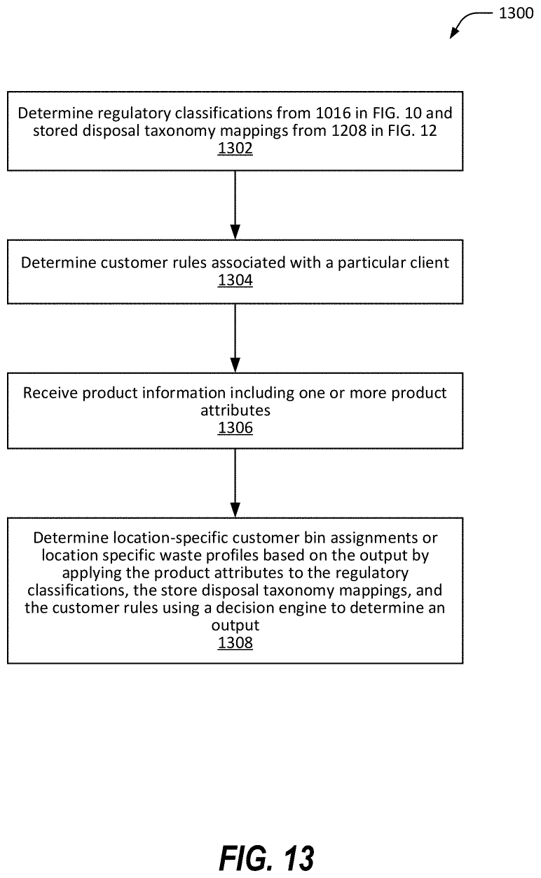

FIG. 13 depicts a flow diagram of a method 1300 of determining location-specific bin assignments or waste profiles) for a product, in accordance with certain embodiments of the present disclosure. At 1302, the method 1300 may include determining regulatory classifications from the data store (block 1016 in FIG. 10) and stored disposal taxonomy mappings from the data store (block 1208 in FIG. 12). In some implementations, the regulatory classifications and the taxonomy mappings may be retrieved from the data store. In other implementations, the regulatory classification and the taxonomy mappings may be provided by another system.

At 1304, the method 1300 may include determining customer rules associated with a particular customer. The customer rules may include disposal preferences for a particular customer. For example, a large retail organization may have waste disposal preferences for all stores, or each store may have its own disposal preferences.

At 1306, the method 1300 may include receiving product information including one or more product attributes. The product information may include the SDS, other information, or any combination thereof.

At 1308, the method 1300 may include determining location-specific customer bin assignments or location-specific waste profiles based on the output by applying the product attributes to the regulatory classifications, the store disposal taxonomy mappings, and customer rules using a decision engine to determine an output. The bins may include temporary storage bins within which one or more products may be stored, temporarily. In some embodiments, the output may include an interface including data, recommendations, prompts, instructions, control elements, or any combination thereof to guide a user in handling the product. In other embodiments, the output may include data and instructions that can be rendered within an Internet-browser application or within a product classification application. Other implementations are also possible.

The output may be provided to one or more customer or client facing devices, such as computing devices executing a product classification application. Other implementations are also possible.

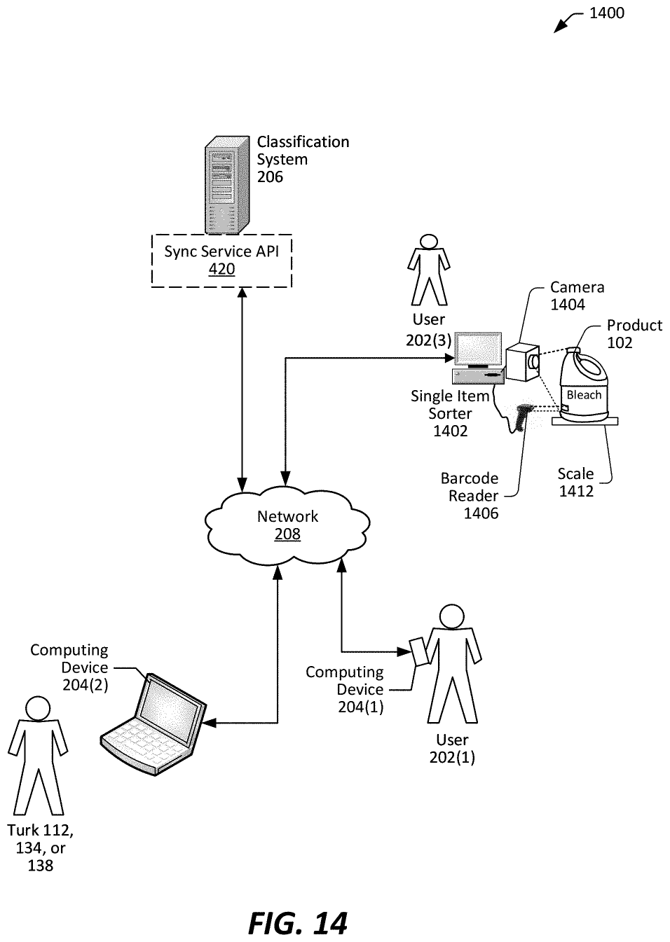

FIG. 14 depicts a system 1400 including a classification system 206 and a plurality of customer-facing applications, in accordance with certain embodiments of the present disclosure. The system 1400 may include one or more computing devices 204 configured to communicate with the classification system 206 through a communications network 208, such as the Internet. The system 1400 may also include a single-item sorter 1402, which may be used at a store location or within a vehicle to enter product information 104.

In this example, the single-item sorter 1402 may include a camera 1404, a barcode reader 1406, or another optical device to capture image data, such as the barcode, image data associated with the packaging, or other optical information about the product 102. The single-item sorter 1402 may also include a scale 1412 to weigh the product 102. The single-item sorter 1402 may also include other input devices, such as a keyboard, a microphone, a scanner, or other input devices, and may include output devices, such as a speaker, a printer, a display, or other output devices.

In some implementations, a user 202(3) of the single-item sorter 1402, a user 202(1) of a hand-held computing device 204(1) (such as a smartphone or tablet computer), or another user 202 of a different computing device 204 may enter product information related to a product 102. The product information 104 may be sent to the classification system 206 via a synchronization service API 420. In response to the product information 104, the classification system 206 may send an output to the computing device 204 or the single-item sorter 1402 from which the product information 104 was received. The output may be provided to a display of the computing device 204 or the single-item sorter 1402 to assist the associated user 202 with handling the product. Other implementations are also possible.

In the illustrated example, when the reliability of a determined regulatory classification or disposal taxonomy is below a threshold reliability value, the classification system 206 may send an alert to the computing device 204(2) associated with one of a Turk 112, 134, or 136 via the network 208 to acquire further information or to have the determined data reviewed as discussed above. Other implementations are also possible.

In conjunction with the systems, devices, and methods of FIGS. 1-14, a system may include an interface configured to communicate with a network and a processor coupled to the interface. The processor may be configured to determine a reliability value of one or more classifications associated with a product is below a threshold value and provide an alert including product data to a first computing device associated with a human operator or Turk user. The product data may include one or more of product information, the reliability value, and the one or more classifications. The alert may include one or more controls accessible by the human operator to edit the product data. The processor may receive the product data from the first computing device, store the product data in a data store, and provide data related to the product data to a second computing device that is associated with a second human operator.

In some implementations, the one or more classifications may include a hazard classification including a first reliability value, a transportation classification including a second reliability value, and a business logic classification including a third reliability value. The processor may be configured to compare the first reliability value to a first threshold value, compare the second reliability value to a second threshold value, and compare the third reliability value to a third threshold value. The first threshold, the second threshold, and the third threshold may be different values.

Although the present invention has been described with reference to preferred embodiments, workers skilled in the art will recognize that changes may be made in form and detail without departing from the scope of the invention.

What is claimed is:

1. A system comprising:
an interface configured to communicate with a network; and
a processor coupled to the interface, the processor to:
determine a reliability value of one or more classifications associated with a product is below a threshold value;
provide an alert including product data to a first computing device associated with a human operator, the product data including one or more of product information, the reliability value, and the one or more classifications, the alert including one or more controls accessible by the human operator to edit the product data;
receive the edited product data from the first computing device;
store the edited product data in a data store; and
provide data related to the edited product data to a second computing device that is associated with a requester.

2. The system of claim 1, wherein the one or more classifications may include one or more of a hazard classification, a transportation classification, or a business logic classification.

3. The system of claim 1, wherein, before determining the reliability value, the processor is configured to:
receive product information related to the product from the second computing device; and
automatically determine the one or more classifications and the reliability value for each of the one or more classifications.

4. The system of claim 3, wherein the processor automatically determines the one or more classifications using one or more deterministic calculations including at least one of a Boolean expression and a chemical reaction calculation.

5. The system of claim 3, wherein the processor is configured to:
parse the product information into one or more temporary tables;
determine the product information is insufficient to perform automatic classification operations; and
send an alert to a third computing device associated with a second human operator, the alert including at least a portion of the product information and including one or more controls accessible by the second human operator to provide further information about the product.

6. The system of claim 3, wherein the processor is configured to:
parse the product information into one or more temporary tables;
automatically search one or more data sources based on the product information to determine further information about the product; and
parse the further information into the one or more temporary tables.

7. The system of claim 1, wherein:
the processor receives information about the product from the second computing device; and
in response to the received information, the processor sends data related to the one or more classifications to the second computing device.

8. A system comprising:
an interface configured to communicate with a network; and
a processor coupled to the interface, the processor to:
receive product information associated with a product;
automatically determine, based on the received product information, one or more classifications and reliability values, each of the reliability values associated with one of the one or more classifications;
when the reliability value is below a threshold value, selectively provide an alert to a first computing device that is associated with a human operator, the alert including one or more of the product information, the one or more classifications, or reliability values and including one or more controls accessible by the human operator to edit or confirm a selected one of the one or more classifications;
receive data from the first computing device based on selection of the one or more controls; and
provide data to a second computing device based on the one or more classifications.

9. The system of claim 8, wherein the one or more classifications may include one or more of a hazard classification, a transportation classification, or a business logic classification.

10. The system of claim 8, wherein the processor is configured to automatically determining the one or more classifications and reliability values by:
apply one or more Boolean expressions to chemical composition data associated with the product to determine one or more first classifications corresponding to the product; and
apply one or more business logic expressions to the chemical composition data associated with the product to determine one or more second classifications corresponding to the product.

11. The system of claim 8, wherein the processor is configured to:
parse the product information into one or more temporary tables;
determine the product information is insufficient to perform automatic classification operations; and
send an alert to a third computing device associated with a mechanical turk, the alert including at least a portion of the product information and including one or more controls accessible by the mechanical turk to provide further information about the product.

12. The system of claim 8, wherein the processor is configured to:
parse the product information into one or more temporary tables;
automatically search one or more data sources based on the product information to determine further information about the product; and
parse the further information into the one or more temporary tables.

13. The system of claim 8, wherein:
the processor receives information about the product from the second computing device; and
in response to the received information, the processor sends data related to the one or more classifications to the second computing device.

14. The system of 8, wherein the data provided to the second computing device includes one or more of a hazard classification, a transportation classification, and a business logic classification.

15. A system comprising:
an interface configured to communicate with a network; and
a processor coupled to the interface, the processor to:
receive product information related to a product;
determine one or more classifications and a reliability value for each of the one or more classifications based on the product information;
provide an alert to a first computing device when the reliability value for at least one of the one or more classifications is below a reliability threshold, the alert including data related to the product and including one or more controls accessible by a human operator to review the one or more classifications;
receive data confirming the one or more classifications from the first computing device; and
provide classification data related to the product to a second computing device.

16. The system of claim 15, wherein the one or more classifications may include one or more of a hazard classification, a transportation classification, or a business logic classification.

17. The system of claim 15, wherein the processor is configured to:
parse the product information into one or more temporary tables;
determine the product information is insufficient to perform automatic classification operations; and
send an alert to a third computing device associated with a mechanical turk, the alert including at least a portion of the product information and including one or more controls accessible by the mechanical turk to provide further information about the product.

18. The system of claim 15, wherein the processor is configured to:
parse the product information into one or more temporary tables;
automatically search one or more data sources based on the product information to determine further information about the product;
parse the further information into the one or more temporary tables; and
determine one or more classifications and a reliability value for each of the one or more classifications based on the product information within the one or more temporary tables.

19. The system of claim 15, wherein the one or more classifications include:
a hazard classification including a first reliability value;
a transportation classification including a second reliability value; and
a business logic classification including a third reliability value.

20. The system of claim 19, wherein the processor is configured to:
compare the first reliability value to a first threshold value;
compare the second reliability value to a second threshold value;
compare the third reliability value to a third threshold value; and
wherein the first threshold, the second threshold, and the third threshold are different values.
